(19) United States
(12) Patent Application Publication
(10) Pub. No.: US 2024/0117275 A1
(43) Pub. Date: Apr. 11, 2024

(54) COMPOSITIONS FOR CLEANING AND METHODS RELATED THERETO

(71) Applicant: DANISCO US INC., PALO ALTO, CA (US)

(72) Inventors: ENDA CAREY, OEGSTGEEST (NL); ARJEN HOEKSTRA, OEGSTGEEST (NL); HELEN S.M. LU, WALLINGFORD, PA (US); RASMUS LETH MILLER, BRABRAND (DK)

(21) Appl. No.: 18/262,023

(22) PCT Filed: Jan. 28, 2022
(86) PCT No.: PCT/US2022/014209

§ 371 Date: Jul. 19, 2023

Related U.S. Application Data
(60) Provisional application No. 63/143,197, filed on Jan. 29, 2021.

(51) Int. Cl. C11D 3/20; C11D 3/22; C11D 3/33; C11D 3/386; C11D 3/43; C11D 11/00

(52) U.S. Cl. CPC C11D 3/2093; C11D 3/2044; C11D 3/2082; C11D 3/222; C11D 3/33; C11D 3/38618; C11D 3/38636; C11D 3/38645; C11D 3/43; C11D 11/0017

(57) ABSTRACT

Disclosed herein are cleaning compositions comprising renewable components. More particularly, the cleaning compositions comprise an organic acid derivative of mono- and diglycerides, a functionalized polymer, an enzyme system, and a polar protic solvent other than water.

This application is a 371 of PCT Application No. PCT/US2022/014209, filed Jan. 28, 2022, which claims the benefit of U.S. Provisional Application No. 63/143,197, filed Jan. 29, 2021, which are herein incorporated by reference in their entirety.

The present disclosure relates to cleaning compositions comprising renewable components. More particularly, the cleaning compositions comprise an anionic surfactant, a functionalized polymer, an enzyme system, and a polar protic solvent other than water.

### BACKGROUND

There is a need in the industry for cleaning compositions that include renewable ingredients, such as ingredients that are not petroleum based. Most cleaning compositions comprise an anionic surfactant to provide foam and solubilization of fat and other soils. Common anionic surfactants are petroleum-based sulfonate or sulfate surfactants such as linear alkylbenzene sulfonate (LAS) and alkyl ethoxy sulfate (AES). In addition, cleaning compositions comprise petroleum-based dispersing (homo, co- or ter-) polymers, for example polyacrylate and/or a maleic acid/acrylic acid copolymer. Cleaning compositions developed for laundry and dishwashing applications typically comprise one or more enzymes to provide soil removal or fabric care benefits. Although enzymes are produced by fermentation using renewable feedstocks, their cleaning action generally requires the presence of a surfactant and a dispersing polymer to solubilize the breakdown products of a soil. Finally, most cleaning compositions comprise a petroleum based polar protic solvent other than water to reduce the viscosity of the formulation to facilitate dosing by the consumer or stabilize the enzyme system. An example of a polar protic solvent other than water is glycerol or propylene glycol.

Several detergents are known that comprise one or more renewable components, however, there remains a need for cleaning compositions comprising renewable components that provide consumer acceptable cleaning performance.

### SUMMARY

In one aspect, cleaning compositions are provided, where the cleaning composition comprises: (a) from 1% to 40% by weight of an organic acid derivative of mono- and diglycerides, (b) from 0.1 to 10% by weight of a functional polysaccharide, (c) an enzyme system comprising from 0.001 to 0.2% enzyme protein by weight of the composition comprising at least a protease and an alpha-amylase, and (d) from 0.5 to 10% by weight of a polar protic solvent, where the polar protic solvent is not water. In one such embodiment, the cleaning composition comprises an organic acid derivative of mono- and diglycerides that is selected from a citric acid ester of mono- and diglycerides (CITREM), a diacetyltartaric acid ester of mono- and diglycerides (DATEM) and mixtures thereof. In some embodiments, the CITREM, a DATEM, or a combination of a CITREM and a DATEM are pumpable.

In some embodiments, the compositions provided herein comprise a functional polysaccharide that is an enzymatically produced glucan which comprises 1,2-, 1,3-, 1,4-, 1,6-, 1,2,6-, 1,3,6-, 1,4,6-alpha glycosidic linkages or various combinations thereof, and the glucan is derivatized by one or more polyether groups, one or more polyamine groups, or a combination of polyether and polyamine groups. In some embodiments, the compositions provided herein comprise a functional polysaccharide that is an enzymatically produced glucan which comprises 1,2-, 1,3-, 1,4-, 1,6-, 1,2,6-, 1,3,6-, 1,4,6-alpha glycosidic linkages or various combinations thereof, and the polyglucan is derivatized by one or more hydrophobic organic group, one or more hydrophilic organic group, or both a hydrophobic and a hydrophilic organic group. In some embodiments, the compositions provided herein comprise a functional polysaccharide that is an enzymatically produced glucan which comprises 1,2-, 1,3-, 1,4-, 1,6-, 1,2,6-, 1,3,6-, 1,4,6-alpha glycosidic linkages or various combinations thereof, and the polyglucan is derivatized by one or more hydrophobic ester group selected from an aryl ester group, a first ester group comprising a first acyl group —CO—R″ wherein R″ comprises a chain of 1 to 24 carbon atoms, a second ester group comprising a second acyl group —CO—Cₓ—COOH wherein —Cₓ— comprises a chain of 2 to 24 carbon atoms, or a combination thereof.

In some embodiments, the cleaning compositions, as provided herein, comprise an enzyme system that comprises a protease and an alpha-amylase, and optionally other enzyme functionalities such as a mannanase, cellulase, lipase, cutinase, perhydrolase, pectate lyase, galactanase, glycosyl hydrolase, nuclease, and a phosphodiesterase.

Also provided are methods for cleaning a fabric or a surface comprising (i) forming an aqueous wash liquor by dissolving a cleaning composition comprising (a) from 1% to 40% by weight of an organic acid derivative of mono- and diglycerides, (b) from 0.1 to 10% by weight of a functional polysaccharide, (c) from 0.001 to 0.5% enzyme protein by weight of the composition comprising at least a protease and an alpha-amylase, and (d) from 0.5 to 10% by weight of a polar protic solvent other than water; and (ii) contacting a fabric or surface with the aqueous wash liquor for from 1 to 50 minutes in a washing step; and (iii) optionally rinsing and drying said fabric or surface.15. The method of claim 14, wherein the functional polysaccharide is an enzymatically produced polyglucan which comprises 1,2-, 1,3-, 1,4-, 1,6-, 1,2,6-, 1,3,6-, 1,4,6-alpha glycosidic linkages or various combinations thereof, and the polyglucan is derivatized by at least one charged organic group.

### DETAILED DESCRIPTION

The present disclosure provides cleaning compositions comprising: an organic acid derivative of mono- and diglycerides, a functional polysaccharide, and at least one enzyme, and, optionally, a polar protic solvent other than water. For example, in one embodiment, the cleaning compositions provided herein comprise from about 1% to about 40% by weight of an organic acid derivative of mono- and diglycerides, from about 0.1 to about 10% by weight of a functional polysaccharide, from about 0.001 to about 0.5% enzyme protein by weight of the composition comprising at least a protease and an alpha-amylase, and from about 0.5 to 10% by weight of a polar protic solvent other than water.

Prior to describing embodiments of present compositions and methods, the following terms are defined.

Unless defined otherwise herein, all technical and scientific terms used herein have the same meaning as commonly understood by one of ordinary skill in the art to which this invention pertains. Although any methods and materials similar or equivalent to those described herein find use in the practice of the present invention, the preferred methods and materials are described herein. Accordingly, the terms defined immediately below are more fully described by reference to the specification as a whole. Also, as used herein, the singular terms “a,” “an,” and “the” include the plural reference unless the context clearly indicates otherwise. It is to be understood that this invention is not limited to the particular methodology, protocols, and reagents described, as these may vary, depending upon the context they are used by those of skill in the art.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The term “fabric” refers to, for example, woven, knit, and non-woven material, as well as staple fibers and filaments that can be converted to, for example, yarns and woven, knit, and non-woven fabrics. The term encompasses material made from natural, as well as synthetic (e.g., manufactured) fibers.

The terry “textile”, as used herein refers to any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used, it is intended to include the broader term textiles as well. In the context of the present application, the terry “textile” is used interchangeably with fabric and cloth.

The term “laundering” includes both household laundering and industrial laundering and means the process of treating textiles with a solution containing a cleaning or detergent composition as provided herein. The laundering process can fir example be carried out using e.g. a household or an industrial washing machine or can be carried out by hand.

The term “wash cycle” refers to a washing operation in which textiles are immersed in a wash liquor, mechanical action of some kind is applied to the textile to release stains or to facilitate flow of wash liquor in and out of the textile and finally the superfluous wash liquor is removed. After one or more wash cycles, the textile is generally rinsed and dried.

The term “wash liquor” is defined herein as the solution or mixture of water and cleaning compositions provided herein.

In one embodiment, the disclosure provides cleaning compositions comprising (a) from 0.1 to 10% by weight of a functional polysaccharide, (b) from 1% to 40% by weight of an organic acid derivative of mono- and diglyceride, (c) from 0.001 to 0.2% enzyme protein by weight of the composition comprising at least a protease and an alpha-amylase, and (d) from 0.5 to 10% of a polar protic solvent other than water.

The functional polysaccharide for use in the compositions herein include any functional polysaccharide. A functional polysaccharide is included in the cleaning composition to, for example, provide cleaning, care or other benefits. The functional polysaccharide can be a hydrocolloid thickener, a dispersing polymer, a cleaning polymer, a dye transfer inhibiting polymer, a fabric enhancement polymer, and mixtures thereof.

In some embodiments, the functional polysaccharide is a hydrocolloid thickener. A hydrocolloid thickener can be selected from the group of xanthan gum, galactomannans, guar, alginate, carrageenan, starch, gellan, carboxymethyl cellulose and mixtures thereof.

In other embodiments, the functional polysaccharide is be a glucan derivative that can comprise one or more polyether groups, one or more polyamine groups, or a combination of polyether and polyamine groups. The functional polysaccharide can be a glucan derivative that is comprised of a glucan modified with at least one hydrophobic group, or one hydrophilic group, or both hydrophobic and hydrophilic groups. The functional polysaccharide can be a glucan substituted with at least one positively charged organic group. A glucan is a polymer comprising glucose monomeric units linked together by alpha-glycosidic linkages. Depending upon with glucan is being described, the alpha glycosidic linkages can be 1,2-, 1,3-, 1,4-, 1,6-, 1,2,6-, 1,3,6-, 1,4,6- or various combinations thereof. Glucan can be made economically from renewably sourced feedstocks. It can be enzymatically produced from sucrose according to the procedures described in WO2015183714, WO2015183722 and WO2015183729.

The terms “glycosidic linkage”, “glycosidic bond”, “linkage” and the like are used interchangeably herein and refer to the covalent bonds connecting the sugar monomers within a saccharide compound (oligosaccharides and/or polysaccharides). The term “alpha-1,2-glycosidic linkage” as used herein refers to the type of covalent bond that joins alpha-D-glucose molecules to each other through carbons 1 and 2 on adjacent alpha-D-glucose rings. The term “alpha-1,3-glycosidic linkage” as used herein refers to the type of covalent bond that joins alpha-D-glucose molecules to each other through carbons 1 and 3 on adjacent alpha-D-glucose rings. The term “alpha-1,4-glycosidic linkage” as used herein refers to the type of covalent bond that joins alpha-D-glucose molecules to each other through carbons 1 and 4 on adjacent alpha-D-glucose rings. The term “alpha-1,6-glycosidic linkage” as used herein refers to the covalent bond that joins alpha-D-glucose molecules to each other through carbons 1 and 6 on adjacent alpha-D-glucose rings. The glycosidic linkages of a glucan polymer herein can also be referred to as “glucosidic linkages”. Herein, “alpha-D-glucose” will be referred to as “glucose”.

The glycosidic linkage profile of an alpha-glucan herein can be determined using any method known in the art. For example, a linkage profile can be determined using methods using nuclear magnetic resonance (NMR) spectroscopy (e.g., ¹³C NMR and/or ¹H NMR). These and other methods that can be used are disclosed in, for example, Food Carbohydrates: Chemistry, Physical Properties, and Applications (S. W. Cui, Ed., Chapter 3, S. W. Cui, Structural Analysis of Polysaccharides, Taylor & Francis Group LLC, Boca Raton, F L, 2005), which is incorporated herein by reference.

The “molecular weight” of alpha-glucan polymers herein can be represented as weight-average molecular weight (Mw) or number-average molecular weight (Mn), the units of which are in Daltons (Da) or grams/mole. Alternatively, the molecular weight of alpha-glucan polymers can be represented as DPw (weight average degree of polymerization) or DPn (number average degree of polymerization). The molecular weight of smaller alpha-glucan polymers such as oligosaccharides can optionally be provided as “DP” (degree of polymerization), which simply refers to the number of glucoses comprised within the alpha-glucan; “DP” can also characterize the molecular weight of a polymer on an individual molecule basis. Various means are known in the art for calculating these various molecular weight measurements such as with high-pressure liquid chromatography (HPLC), size exclusion chromatography (SEC), or gel permeation chromatography (GPC).

As used herein, Mw can be calculated as Mw=ΣNiMi²/ΣNiMi; where Mi is the molecular weight of an individual chain i and Ni is the number of chains of that molecular weight. Besides SEC, the Mw of a polymer can be determined by other techniques such as static light scattering, mass spectrometry, MALDI-TOF (matrix-assisted laser desorption/ionization time-of-flight), small angle X-ray or neutron scattering, or ultracentrifugation. As used herein, Mn can be calculated as Mn=ΣNiMiΣNi where Mi is the molecular weight of a chain i and Ni is the number of chains of that molecular weight. Besides SEC, the Mn of a polymer can be determined by various colligative property methods such as vapor pressure osmometry, end-group determination by spectroscopic methods such as proton NMR, proton FTIR, or UV-Vis. As used herein, DPn and DPw can be calculated from Mw and Mn, respectively, by dividing them by molar mass of the one monomer unit M₁. In the case of unsubstituted glucan polymer, M₁=162. In the case of a substituted (derivatized) glucan polymer, M₁=162+M_{f}×DoS, where M_{f} is molar mass of the substituting group, and DoS is degree of substitution (average number of substituted groups per one glucose unit of the glucan polymer).

The terms “alpha-glucan”, “alpha-glucan polymer” and the like are used interchangeably herein. An alpha-glucan is a polymer comprising glucose monomeric units linked together by alpha-glycosidic linkages. In typical embodiments, an alpha-glucan herein comprises 100% alpha-glycosidic linkages, or at least about 80%, 81%, 82%, 83%, 84%, 85%, 86%, 87%, 88%, 89%, 90%, 91%, 92%, 93%, 94%, 95%, 96%, 97%, 98%, or 99% alpha-glycosidic linkages. Examples of alpha-glucan polymers herein include alpha-1,2-glucan, alpha-1,3-glucan, alpha-1,4-glucan, alpha-1,6-glucan, alpha-1,2,6-glucan, alpha-1,3,6-glucan, alpha-1,4,6-glucan, etc.

The terms “dextran”, “dextran polymer”, “dextran molecule” and the like in some aspects herein refer to a water-soluble alpha-glucan comprising at least 50%, 60%, 70%, 80%, 90%, 95%, 96%, 97%, 98%, 99%, or 99.5% alpha-1,6 glycosidic linkages (with the balance of the linkages typically being all or mostly alpha-1,3). Enzymes capable of synthesizing dextran from sucrose may be described as “dextransucrases” (EC 2.4.1.5). As used herein, the term “dextranase” (alpha-1,6-glucan-6-glucanohydrolase; EC 3.2.1.11) refers to an enzyme capable of endohydrolysing 1,6-alpha glycosidic linkages.

The terms “poly alpha-1,3-glucan”, “alpha-1,3-glucan”, “alpha-1,3-glucan polymer” and the like are used interchangeably herein. Alpha-1,3-glucan is a polymer comprising glucose monomeric units linked together by glycosidic linkages, wherein at least about 50% of the glycosidic linkages are alpha-1,3. Alpha-1,3-glucan in certain embodiments comprises at least 90% or 95% alpha-1,3 glycosidic linkages. Most or all of the other linkages in alpha-1,3-glucan herein typically are alpha-1,6, though some linkages may also be alpha-1,2 and/or alpha-1,4.

The terms “poly alpha-1,4-glucan”, “alpha-1,4-glucan”, “alpha-1,4-glucan polymer” and the like are used interchangeably herein. Alpha-1,4-glucan is a polymer of at least DP3 and comprises glucose monomeric units linked together by glycosidic linkages, wherein at least about 90% of the glycosidic linkages are alpha-1,4. Alpha-1,4-glucan in certain embodiments has about 100% alpha-1,4 glycosidic linkages, or comprises at least about 90% or 95% alpha-1,4 glycosidic linkages. Most or all of other linkages (if present) in alpha-1,4-glucan herein typically are alpha-1,6 (typically forming a branch), but can also be alpha-1,2 and/or alpha-1,3. An example of alpha-1,4-glucan herein is amylose.

In some embodiments, the poly alpha-1,6-glucan derivative for use in the compositions provided herein comprises a backbone of glucose monomer units where greater than or equal to 40%, 45%, 50%, 55%, 60%, 65%, 70%, 75%, 80%, 85%, 90%, 95%, 96%, 97%, 98%, 99%, 99.5%, or 100% of the glucose monomer units are linked via alpha-1,6-glycosodic linkages. The backbone of the poly alpha-1,6-glucan derivative can comprise 0.5%, 1%, 2%, 3%, 4%, 5%, 10%, 15%, 20%, 25%, 30%, 35%, 40%, 45%, 50%, 55%, or 60% glucose monomer units which are linked via alpha-1,2, alpha-1,3, and/or alpha-1,4 glycosidic linkages. In some aspects, the poly alpha-1,6-glucan derivative comprises a backbone that is linear (unbranched).

Glucan “long chains” can comprise “substantially (or mostly) alpha-1,6-glucosidic (or, alpha-1,3-glucosidic, etc) linkages”, meaning that they can have at least about 98.0%, e.g., alpha-1,6-glucosidic (or, alpha-1,3-glucosidic, etc) linkages in some aspects. In some embodiments, the alpha-glucan derivatives that can be used in the compositions herein can comprise a “branching structure” (branched structure, dendritic). It is contemplated that in this structure, long chains branch from other long chains, likely in an iterative manner (e.g., a long chain can be a branch from another long chain, which in turn can itself be a branch from another long chain, and so on). It is contemplated that long chains in this structure can be “similar in length”, meaning that the length (DP [degree of polymerization]) of at least 70% of all the long chains in a branching structure is within plus/minus 30% of the mean length of all the long chains of the branching structure.

In some embodiments the glucans for use in the cleaning compositions herein can also comprise “short chains” branching from the long chains, typically being one to three glucose monomers in length, and typically comprising less than about 10% of all the glucose monomers of a dextran polymer. Such short chains typically comprise alpha-1,2-, alpha-1,3-, and/or alpha-1,4-glucosidic linkages (it is understood that there can also be a small percentage of such non-alpha-1,6 linkages in long chains in some aspects). In certain embodiments, the poly-1,6-glucan with branching is produced enzymatically according to the procedures in WO2015/183714 and WO2017/091533 (both incorporated herein by reference) where, for example, alpha-1,2-branching enzymes such as GTFJ18T1 or GTF9905 can be added during or after the production of the dextran polymer (polysaccharide). In some embodiments, any other enzyme known to produce alpha-1,2-branching can be added. Poly alpha-1,6-glucan with alpha-1,3-branching can be prepared as disclosed in Vuillemin et al. (2016, J. Biol Chem. 291:7687-7702) or U.S. Appl. No. 62/871,796, which are incorporated herein by reference. The degree of branching of poly alpha-1,6-glucan or a poly alpha-1,6-glucan derivative in such embodiments has less than or equal to 50%, 40%, 30%, 20%, 10%, or 5% (or any integer value between 5% and 50%) of short branching, for example alpha-1,2-branching or 1,3-branching. In one embodiment, the poly alpha-1,6-glucan or the poly alpha-1,6-glucan derivative has a degree of alpha-1,2-branching that is less than 50%. In another embodiment, the poly alpha-1,6-glucan or the poly alpha-1,6-glucan derivative has a degree of alpha-1,2-branching that is at least 3%. In one embodiment, at least 3% of the backbone glucose monomer units of the poly alpha-1,6-glucan derivative have branches via alpha-1,2- or alpha-1,3-glycosidic linkages. In one embodiment, the poly apha-1,6-glucan or the poly alpha-1,6-glucan derivative comprises a backbone of glucose monomer units wherein greater than or equal to 40% of the glucose monomer units are linked via alpha-1,6-glycosidic linkages. In one embodiment, the poly alpha-1,6-glucan derivative comprises a backbone of glucose monomer units wherein greater than or equal to 40% of the glucose monomer units are linked via alpha-1,6-glycosidic linkages and at least 3% of the glucose monomer units have branches via alpha-1,2- or alpha-1,3-glycosidic linkages. In one embodiment, the poly alpha-1,6-glucan derivative comprises a backbone of glucose monomer units wherein greater than or equal to 40% of the glucose monomer units are linked via alpha-1,6-glycosidic linkages and at least 3% of the glucose monomer units have branches via alpha-1,2 linkages. In one embodiment, the poly alpha-1,6-glucan derivative comprises a backbone of glucose monomer units wherein greater than or equal to 40% of the glucose monomer units are linked via alpha-1,6-glycosidic linkages and at least 3% of the glucose monomer units have branches via alpha-1,3 linkages. In one embodiment, the poly alpha-1,6-glucan or poly alpha-1,6-glucan derivative is linear, or predominantly linear. In some aspects, about, at least about, or less than about, 1%, 2%, 3%, 4%, 5%, 10%, 15%, 20%, 25%, 30%, 35%, 40%, 50%, 55%, 60%, 65%, 70%, 75%, 80%, 85%, or 90% of the backbone glucose monomer units of a poly alpha-1,6-glucan or derivative thereof as presently disclosed can have branches via alpha-1,2 and/or alpha-1,3 glycosidic linkages. In some aspects, about, at least about, or less than about, 1%, 2%, 2.5%, 5%, 10%, 15%, 20%, 25%, 30%, 35%, 40%, or 45% of all the glycosidic linkages of an alpha-1,2- and/or alpha-1,3-branched poly alpha-1,6-glucan or derivative thereof as presently disclosed are alpha-1,2 and/or alpha-1,3 glycosidic linkages. The amount of alpha-1,2-branching or alpha-1,3-branching can be determined by NMR methods, as disclosed in the Examples.

The poly alpha-1,6-glucan and poly alpha-1,6-glucan derivatives for use in the cleaning compositions herein can have a number-average degree of polymerization (DPn) or weight-average degree of polymerization (DPw) in the range of 5 to 6000. In some embodiments, the DPn or DPw can be in the range of 5 to 100, 5 to 500, 5 to 1000, 5 to 1500, 5 to 2000, 5 to 2500, 5 to 3000, 5 to 4000, 5 to 5000, or 5 to 6000. In some embodiments, the DPn or DPw can be in the range of 50 to 500, 50 to 1000, 50 to 1500, 50 to 2000, 50 to 3000, 50 to 4000, 50 to 5000, or 50 to 6000. In some embodiments, the DPn or DPw can be in the range of 400 to 6000, 400 to 5000, 400 to 4000, 400 to 3000, 400 to 2000, or 400 to 1000. In some embodiments, the DPn or DPw can be about, at least about, or less than about, 5, 10, 25, 50, 100, 250, 500, 1000, 1500, 2000, 2500, 3000, 4000, 5000, 6000, 5-100, 5-250, 5-500, 5-1000, 5-1500, 5-2000, 5-2500, 5-3000, 5-4000, 5-5000, 5-6000, 10-100, 10-250, 10-500, 10-1000, 10-1500, 10-2000, 10-2500, 10-3000, 10-4000, 10-5000, 10-6000, 25-100, 25-250, 25-500, 25-1000, 25-1500, 25-2000, 25-2500, 25-3000, 25-4000, 25-5000, 25-6000, 50-100, 50-250, 50-500, 50-1000, 50-1500, 50-2000, 50-2500, 50-3000, 50-4000, 50-5000, 50-6000, 100-100, 100-250, 100-500, 100-1000, 100-1500, 100-2000, 100-2500, 100-3000, 100-4000, 100-5000, 100-6000, 250-500, 250-1000, 250-1500, 250-2000, 250-2500, 250-3000, 250-4000, 250-5000, 250-6000, 500-1000, 500-1500, 500-2000, 500-2500, 500-3000, 500-4000, 500-5000, 500-6000, 750-1000, 750-1500, 750-2000, 750-2500, 750-3000, 750-4000, 750-5000, 750-6000, 1000-1400, 1000-1500, 1000-2000, 1000-2500, 1000-3000, 1000-4000, 1000-5000, 1000-6000, or 1100-1300.

In some embodiments, the alpha-1,3-glucan derivative for use in the cleaning compositions herein can comprise about, or at least about, 30%, 40%, 50%, 60%, 70%, 80%, 85%, 90%, 91%, 92%, 93%, 94%, 95%, 96%, 97%, 98%, 99%, 99.5%, or 100% alpha-1,3 glycosidic linkages. In some aspects, accordingly, insoluble alpha-1,3-glucan has less than about 70%, 60%, 50%, 40%, 30%, 20%, 15%, 10%, 9%, 8%, 7%, 6%, 5%, 4%, 3%, 2%, 1%, 0.5%, or 0% glycosidic linkages that are not alpha-1,3. Typically, the glycosidic linkages that are not alpha-1,3 are mostly or entirely alpha-1,6. In certain embodiments, insoluble alpha-1,3-glucan has no branch points or less than about 5%, 4%, 3%, 2%, or 1% branch points as a percent of the glycosidic linkages in the glucan.

The DPw, DPn, or DP of the alpha-1,3-glucan derivative for use in the cleaning compositions herein in certain aspects can be about, or at least about, or less than about, 11, 12, 15, 20, 25, 30, 35, 40, 41, 42, 43, 44, 45, 46, 47, 48, 49, 50, 51, 52, 53, 54, 55, 56, 57, 58, 59, 60, 65, 70, 75, 80, 85, 90, 95, 100, 110, 125, 150, 175, 200, 300, 400, 500, 600, 700, 800, 900, 1000, 1100, 1200, 1300, 1400, 1500, 1600, or 1650. DPw, DPn, or DP can optionally be expressed as a range between any two of these values. Merely as examples, the DPw, DPn, or DP of alpha-1,3-glucan herein can be about 400-1650, 500-1650, 600-1650, 700-1650, 400-1250, 500-1250, 600-1250, 700-1250, 400-1000, 500-1000, 600-1000, 700-1000, 400-900, 500-900, 600-900, 700-900, 11-25, 12-25, 11-22, 12-22, 11-20, 12-20, 20-300, 20-200, 20-150, 20-100, 20-75, 30-300, 30-200, 30-150, 30-100, 30-75, 50-300, 50-200, 50-150, 50-100, 50-75, 75-300, 75-200, 75-150, 75-100, 100-300, 100-200, 100-150, 150-300, 150-200, 200-300, 15-100, 25-100, 35-100, 15-80, 25-80, 35-80, 15-60, 25-60, 35-60, 15-55, 25-55, 35-55, 40-100, 40-80, 40-60, 40-55, 40-50, 45-60, 45-55, or 45-50. DP can be referenced, for example, for alpha-1,3-glucan of relatively low molecular weight such as 200, 100, 50, or less DP.

In some embodiments, the cleaning compositions provided herein can comprise an alpha-1,4-glucan derivative. An alpha-1,4-glucan can be produced, for example, by an alpha-1,4 glucan phosphorylase reaction. In some aspects, about, or at least about, 90%, 91%, 92%, 93%, 94%, 95%, 96%, 97%, 98%, 99%, 99.5%, or 100% of the constituent glycosidic linkages of alpha-1,4-glucan herein are contemplated to be alpha-1,4-linkages. In some aspects, accordingly, alpha-1,4-glucan has about, or less than about, 10%, 9%, 8%, 7%, 6%, 5%, 4%, 3%, 2%, 1%, 0.5%, or 0% glycosidic linkages that are not alpha-1,4. It should be understood that the higher the percentage of alpha-1,4 linkages present in alpha-1,4-glucan, the greater the probability that the alpha-1,4-glucan is linear, since there are lower occurrences of certain linkages forming branch points in the polymer. Thus, alpha-1,4-glucan with 100% alpha-1,4 linkages is completely linear. In certain embodiments, alpha-1,4-glucan has no branch points or less than about 5%, 4%, 3%, 2%, or 1% branch points (typically beta-1,6) as a percent of the glycosidic linkages in the polymer. In some aspects, a given linkage profile characterizes that of the alpha-1,4-glucan as synthesized from an acceptor (i.e., the linkage profile does not include the linkage profile of the acceptor). In aspects in which an alpha-1,4-glucan itself (e.g., alpha-1,4-glucan oligosaccharide) is used as the initial acceptor molecule, any of the foregoing linkage percentages can optionally characterize the entire product.

Alpha-1,4-glucan herein (typically insoluble) is contemplated to have a molecular weight in DPw or DPn of about, or at least about, 40, 50, 60, 70, 80, 90, 100, 150, 200, 250, 300, 350, 400, 450, 500, 600, 700, 800, 900, or 1000, or a range between any two of these values such as 200-600, 200-500, 200-450, 250-600, 250-500, 250-450, 300-600, 300-500, 300-450, 350-600, 350-500, or 350-450, for example. In some aspects, a given molecular weight characterizes that of the alpha-1,4-glucan as synthesized from an acceptor (i.e., the molecular weight does not include the molecular weight of the acceptor). In aspects in which an alpha-1,4-glucan itself (e.g., alpha-1,4-glucan oligosaccharide) is used as the initial acceptor molecule, any of the foregoing molecular weight disclosures can optionally characterize the entire product.

The glucans for use in the compositions provided herein, including those with 1,2-, 1,3-, 1,4-, 1,6-, 1,2,6-, 1,3,6-, 1,4,6- or various combinations thereof alpha glycosidic linkages, can be in any derivatized form, preferably derivatized to improve their functionality. For example, the glucan derivative for use in the compositions herein can be a neutral or anionic ether, a cationic ether, a mixed ether (e.g. amphiphilic), or an ester derivative.

In some embodiments, the glucan derivative for use in the compositions herein include a neutral or anionic ether. An organic group that is in ether-linkage to a graft copolymer herein can be an alkyl group, for example. An alkyl group can be a linear, branched, or cyclic (“cycloalkyl” or “cycloaliphatic”) in some aspects. In some aspects, an alkyl group is a C₁ to C₁₈ alkyl group, such as a C₄ to C₁₈ alkyl group, or a C₁ to C₁₀ alkyl group (in “C_{#}”, #refers to the number of carbon atoms in the alkyl group). An alkyl group can be, for example, a methyl, ethyl, propyl, butyl, pentyl, hexyl, heptyl, octyl, nonyl, decyl, undecyl, dodecyl, tridecanyl, tetradecanyl, pentadecanyl, hexadecanyl, heptadecanyl, or octadecanyl group; such alkyl groups typically are linear. One or more carbons of an alkyl group can be substituted with another alkyl group in some aspects, making the alkyl group branched. Suitable examples of branched chain isomers of linear alkyl groups include isopropyl, iso-butyl, tert-butyl, sec-butyl, isopentyl, neopentyl, isohexyl, neohexyl, 2-ethylhexyl, 2-propylheptyl, and isooctyl. In some aspects, an alkyl group is a cycloalkyl group such as a cyclopentyl, cyclohexyl, cycloheptyl, cyclooctyl, cyclononyl, or cyclodecyl group.

In some aspects, an organic group that is in ether-linkage to a glucan for use herein can be a substituted alkyl group in which there is a substitution on one or more carbons of the alkyl group. The substitution(s) can be one or more hydroxyl, aldehyde, ketone, and/or carboxyl groups. For example, a substituted alkyl group may be a hydroxy alkyl group, dihydroxy alkyl group, or carboxy alkyl group. Examples of suitable hydroxy alkyl groups are hydroxymethyl (CH₂OH), hydroxyethyl (e.g., CH₂CH₂OH, CH(OH)CH₃), hydroxypropyl (e.g., CH₂CH₂CH₂OH, CH₂CH(OH)CH₃, CH(OH)CH₂CH₃), hydroxybutyl and hydroxypentyl groups. Other examples include dihydroxy alkyl groups (diols) such as dihydroxymethyl, dihydroxyethyl (e.g., —CH(OH)CH₂OH), dihydroxypropyl (e.g., CH₂CH(OH)CH₂OH, CH(OH)CH(OH)CH₃), dihydroxybutyl and dihydroxypentyl groups. Examples of suitable carboxy alkyl groups are carboxymethyl (CH₂COOH), carboxyethyl (e.g., CH₂CH₂COOH, CH(COOH)CH₃), carboxypropyl (e.g., CH₂CH₂CH₂COOH, CH₂CH(COOH)CH₃, CH(COOH)CH₂CH₃), carboxybutyl and carboxypentyl groups.

In some aspects, one or more carbons of an alkyl group that is in ether-linkage to a glucan derivative for use herein can have a substitution(s) with another alkyl group. Examples of such substituent alkyl groups are methyl, ethyl and propyl groups. To illustrate, an organic group can be CH(CH₃)CH₂CH₃ or CH₂CH(CH₃)CH₃, for example, which are both propyl groups having a methyl substitution.

As should be clear from the above examples of various substituted alkyl groups, a substitution (e.g., hydroxy or carboxy group) on an alkyl group in some aspects can be at the terminal carbon atom of the alkyl group, where the terminal carbon group is opposite the side of the alkyl group that is in ether linkage to a glucose monomeric unit of a graft copolymer ether compound. An example of this terminal substitution is the hydroxypropyl group —CH₂CH₂CH₂OH. Alternatively, a substitution can be on an internal carbon atom of an alkyl group. An example of an internal substitution is the hydroxypropyl group CH₂CH(OH)CH₃. An alkyl group can have one or more substitutions, which may be the same (e.g., two hydroxyl groups [dihydroxy]) or different (e.g., a hydroxyl group and a carboxyl group).

Optionally, an etherified alkyl group herein can contain one or more heteroatoms such as oxygen, sulfur, and/or nitrogen within the hydrocarbon chain. Examples include alkyl groups containing an alkyl glycerol alkoxylate moiety (-alkylene-OCH₂CH(OH)CH₂OH), a moiety derived from ring-opening of 2-ethylhexl glycidyl ether, and a tetrahydropyranyl group (e.g., as derived from dihydropyran).

In some aspects, an etherified organic group is a C₂ to C₁₈ (e.g., C₄ to C₁₈) alkenyl group, and the alkenyl group may be linear, branched, or cyclic. As used herein, the term “alkenyl group” refers to a hydrocarbon group containing at least one carbon-carbon double bond. Examples of alkenyl groups include ethenyl, propenyl, butenyl, pentenyl, hexenyl, cyclohexyl, and allyl groups. In some aspects, one or more carbons of an alkenyl group can have substitution(s) with an alkyl group, hydroxyalkyl group, or dihydroxy alkyl group such as disclosed herein. Examples of such a substituent alkyl group include methyl, ethyl, and propyl groups. Optionally, an alkenyl group herein can contain one or more heteroatoms such as oxygen, sulfur, and/or nitrogen within the hydrocarbon chain; for example, an alkenyl group can contain a moiety derived from ring-opening of an allyl glycidyl ether.

In some aspects, an etherified organic group is a C₂ to C₁₈ alkynyl group. As used herein, the term “alkynyl” refers to linear and branched hydrocarbon groups containing at least one carbon-carbon triple bond. An alkynyl group herein can be, for example, propynyl, butynyl, pentynyl, or hexynyl. An alkynyl group can optionally be substituted, such as with an alkyl, hydroxyalkyl, and/or dihydroxy alkyl group. Optionally, an alkynyl group can contain one or more heteroatoms such as oxygen, sulfur, and/or nitrogen within the hydrocarbon chain.

In some aspects, an etherified organic group is a polyether comprising repeat units of (—CH₂CH₂O—), (—CH₂CH(CH₃)O—), or a mixture thereof, wherein the total number of repeat units is in the range of 2 to 100. In some aspects, an organic group is a polyether group comprising (—CH₂CH₂O—)₃₋₁₀₀ or (—CH₂CH₂O—)₄₋₁₀₀. In some aspects, an organic group is a polyether group comprising (CH₂CH(CH₃)O)₃₋₁₀₀ or (CH₂CH(CH₃)O)₄₋₁₀₀. As used herein for a polyether group, the subscript designating a range of values designates the potential number of repeat units; for example, (CH₂CH₂O)₂₋₁₀₀ means a polyether group containing 2 to 100 repeat units. In some aspects, a polyether group herein can be capped such as with a methoxy, ethoxy, or propoxy group.

In some aspects, an etherified organic group is an aryl group. As used herein, the term “aryl” means an aromatic/carbocyclic group having a single ring (e.g., phenyl), multiple rings (e.g., biphenyl), or multiple condensed rings in which at least one is aromatic, (e.g., 1,2,3,4-tetrahydronaphthyl, naphthyl, anthryl, or phenanthryl), which is optionally mono-, di-, or trisubstituted with alkyl groups, such as a methyl, ethyl, or propyl group. In some aspects, an aryl group is a C₆ to C₂₀ aryl group. In some aspects, an aryl group is a methyl-substituted aryl group such as a tolyl (—C₆H₄CH₃) or xylyl [—C₆H₃(CH₃)₂] group. A tolyl group can be a p-tolyl group, for instance. In some aspects, an aryl group is a benzyl group (—CH₂-phenyl). A benzyl group herein can optionally be substituted (typically on its phenyl ring) with one or more of a halogen, cyano, ester, amide, ether, alkyl (e.g., C₁ to C₆), aryl (e.g., phenyl), alkenyl (e.g., C₂ to C₆), or alkynyl (e.g., C₂ to C₆) group.

In some embodiments, the glucan derivative for use in the compositions herein include a cationic ether derivative. That is, an organic group that can be in an ether-linkage to a glucan for use in the compositions herein can be a positively charged (cationic) group, for example. A positively charged organic group as used herein refers to a chain of one or more carbons (“carbon chain”) that has one or more hydrogens substituted with another atom or functional group (i.e., a “substituted alkyl group”), where one or more of the substitutions is with a positively charged group. Where a positively charged organic group has a substitution in addition to a substitution with a positively charged group, such additional substitution may be with one or more hydroxyl groups, oxygen atoms (thereby forming an aldehyde or ketone group), alkyl groups, and/or additional positively charged groups. A positively charged organic group has a net positive charge since it comprises one or more positively charged groups. The terms “positively charged group”, “positively charged ionic group”, “cationic group” and the like are used interchangeably herein. A positively charged group comprises a cation (a positively charged ion). Examples of positively charged groups include substituted ammonium groups, carbocation groups and acyl cation groups.

A positively charged group can be, for example, any of those disclosed in U.S. Pat. Appl. Publ. No. 2016/0311935, which is incorporated herein by reference. A positively charged group can comprise a substituted ammonium group, for example. Examples of substituted ammonium groups are primary, secondary, tertiary and quaternary ammonium groups, such as can be represented by Structures I and II. An ammonium group can be substituted with alkyl group(s) and/or aryl group(s), for example. There can be one, two, or three alkyl and/or aryl groups in some aspects. An alkyl group of a substituted ammonium group herein can be a C₁-C₃₀ alkyl group, for example, such as a methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, C₂₅, C₂₆, C₂₇, C₂₈, C₂₉, or C₃₀ group; each alkyl group can be the same or different is aspects with two or three alkyl substitutions. An alkyl group can be C₁-C₂₄, C₁-C₁₈, C₆-C₂₀, C₁₀-C₁₆, or C₁-C₄ in some aspects. An aryl group of a substituted ammonium group herein can be as disclosed above, for example. In some additional aspects, an aryl group can be a C₆-C₂₄, C₁₂-C₂₄, or C₆-C₁₈ aryl group that is optionally substituted with alkyl substituents (e.g., any alkyl group disclosed herein).

A secondary ammonium glucan ether compound for use in the compositions herein can comprise a monoalkylammonium group in some aspects (e.g., based on Structure I). A secondary ammonium glucan ether compound can be a monoalkylammonium graft copolymer ether in some aspects, such as a monomethyl-, monoethyl-, monopropyl-, monobutyl-, monopentyl-, monohexyl-, monoheptyl-, monooctyl-, monononyl-, monodecyl-, monoundecyl-, monododecyl-, monotridecyl-, monotetradecyl-, monopentadecyl-, monohexadecyl-, monoheptadecyl-, or monooctadecyl-ammonium graft copolymer ether. These glucan ether compounds can also be referred to as methyl-, ethyl-, propyl-, butyl-, pentyl-, hexyl-, heptyl-, octyl-, nonyl-, decyl-, undecyl-, dodecyl-, tridecyl-, tetradecyl-, pentadecyl-, hexadecyl-, heptadecyl-, or octadecyl-ammonium graft copolymer ether compounds, respectively.

A tertiary ammonium glucan ether compound for use in the compositions herein can comprise a dialkylammonium group in some aspects (e.g., based on Structure I). A tertiary ammonium glucan ether compound can be a dialkylammonium glucan ether in some aspects, such as a dimethyl-, diethyl-, dipropyl-, dibutyl-, dipentyl-, dihexyl-, diheptyl-, dioctyl-, dinonyl-, didecyl-, diundecyl-, didodecyl-, ditridecyl-, ditetradecyl-, dipentadecyl-, dihexadecyl-, diheptadecyl-, or dioctadecyl-ammonium glucan ether.

A quaternary ammonium glucan ether compound for use in the compositions herein can comprise a trialkylammonium group in some aspects (e.g., based on Structure I). A quaternary ammonium glucan ether compound can a trialkylammonium glucan ether in some aspects, such as trimethyl-, triethyl-, tripropyl-, tributyl-, tripentyl-, trihexyl-, triheptyl-, trioctyl-, trinonyl-, tridecyl-, triundecyl-, tridodecyl-, tritridecyl-, tritetradecyl-, tripentadecyl-, trihexadecyl-, triheptadecyl-, or trioctadecyl-ammonium glucan ether.

One of the groups of a substituted ammonium group comprises one carbon, or a chain of carbons (e.g., up to 30), in ether linkage to a glucan. A carbon chain in this context can be linear, for example. Such a carbon or carbon chain can be represented by CH₂, CH₂CH₂, —CH₂CH₂CH₂, CH₂(CH₂)₂CH₂, CH₂(CH₂)₃CH₂, CH₂(CH₂)₄CH₂, CH₂(CH₂)₅CH₂, CH₂(CH₂)₆CH₂, CH₂(CH₂)₇CH₂, CH₂(CH₂)₈CH₂, CH₂(CH₂)₉CH₂, or CH₂(CH₂)₁₀CH₂, for example. In some aspects, a carbon chain in this context can be branched, such as by being substituted with one or more alkyl groups (e.g., any as disclosed above such as methyl, ethyl, propyl, or butyl). The point(s) of substitution can be anywhere along the carbon chain. Examples of branched carbon chains include CH(CH₃)CH₂, CH(CH₃)CH₂CH₂, CH₂CH(CH₃)CH₂, CH(CH₂CH₃)CH₂, —CH(CH₂CH₃)CH₂CH₂, CH₂CH(CH₂CH₃)CH₂, CH(CH₂CH₂CH₃)CH₂, —CH(CH₂CH₂CH₃)CH₂CH₂ and CH₂CH(CH₂CH₂CH₃)CH₂; longer branched carbon chains can also be used, if desired. In some aspects, a chain of one or more carbons (e.g., any of the above linear or branched chains) is further substituted with one or more hydroxyl groups. Examples of hydroxy- or dihydroxy (diol)-substituted chains include CH(OH), CH(OH)CH₂, C(OH)₂CH₂, —CH₂CH(OH)CH₂, CH(OH)CH₂CH₂, CH(OH)CH(OH)CH₂, CH₂CH₂CH(OH)CH₂, —CH₂CH(OH)CH₂CH₂, CH(OH)CH₂CH₂CH₂, CH₂CH(OH)CH(OH)CH₂, —CH(OH)CH(OH)CH₂CH₂ and CH(OH)CH₂CH(OH)CH₂. In each of the foregoing examples, the first carbon atom of the chain is ether-linked to a glucose monomer of the glucan, and the last carbon atom of the chain is linked to a positively charged group (e.g., a substituted ammonium group as disclosed herein). One or more positively charged organic groups in some aspects can be trimethylammonium hydroxypropyl groups (Structure II, when each of R₂, R₃ and R₄ is a methyl group).

In aspects in which a carbon chain of a positively charged organic group has a substitution in addition to a substitution with a positively charged group, such additional substitution can be with one or more hydroxyl groups, oxygen atoms (thereby forming an aldehyde or ketone group), alkyl groups (e.g., methyl, ethyl, propyl, butyl), and/or additional positively charged groups, for example. A positively charged group is typically bonded to the terminal carbon atom of the carbon chain. A positively charged group can also comprise imidazoline ring-containing compounds in some aspects.

A counter ion for a positively charged organic group herein can be any suitable anion, such as an acetate, borate, bromate, bromide, carbonate, chlorate, chloride, chlorite, dihydrogen phosphate, fluoride, hydrogen carbonate, hydrogen phosphate, hydrogen sulfate, hydrogen sulfide, hydrogen sulfite, hydroxide, hypochlorite, iodate, iodide, nitrate, nitride, nitrite, oxalate, oxide, perchlorate, permanganate, phosphate, phosphide, phosphite, silicate, stannate, stannite, sulfate, sulfide, sulfite, tartrate, or thiocyanate anion.

In some embodiments, the glucan derivative for use in the compositions herein include derivatives having two or more different types of etherified organic groups (i.e. mixed ether of a glucan). Examples of such compounds contain (i) two different alkyl groups as etherified organic groups, (ii) an alkyl group and a hydroxy alkyl group as etherified organic groups (alkyl hydroxyalkyl graft copolymer), (iii) an alkyl group and a carboxy alkyl group as etherified organic groups (alkyl carboxyalkyl graft copolymer), (iv) a hydroxy alkyl group and a carboxy alkyl group as etherified organic groups (hydroxyalkyl carboxyalkyl graft copolymer), (v) two different hydroxy alkyl groups as etherified organic groups, or (vi) two different carboxy alkyl groups as etherified organic groups. Specific non-limiting examples of such compounds include ethyl hydroxyethyl graft copolymer, hydroxyalkyl methyl graft copolymer, carboxymethyl hydroxyethyl graft copolymer, and carboxymethyl hydroxypropyl graft copolymer.

Dextran-alpha-glucan graft copolymer ether compounds for use in the compositions herein can comprise at least one type of etherified nonionic organic group and at least one type of etherified negatively charged (anionic) group, for example. As another example, glucan ether compounds for use in the compositions herein can comprise at least one type of etherified nonionic organic group and at least one type of etherified positively charged (cationic) organic group. As another example, glucan ether compounds for use in the compositions herein can comprise at least one type of etherified anionic organic group (e.g., carboxyalkyl such as carboxymethyl) and at least one type of etherified cationic organic group (e.g., substituted ammonium group such as trimethylammonium hydroxypropyl). Examples of the different groups in all these aspects are as presently disclosed. An ether derivative of an alpha-glucan homopolymer herein, in the presence or absence of a graft copolymer ether as presently disclosed, can have any of the foregoing mono-ether or mixed ether profiles (e.g., comprise at least one type of etherified anionic organic group and at least one type of etherified cationic organic group). An alpha-glucan homopolymer mono- or mixed ether compound can be comprised in any composition/product/application as described herein, either with or without a dextran-alpha-glucan graft copolymer ether. In some embodiments, the glucan derivative for use in the compositions herein include derivatives having an ester derivative. Such a derivative can be termed as a graft copolymer ester, for example. An esterified acyl group (ester group) herein can be any as disclosed in, for example, U.S. Patent Appl. Publ. Nos. 2014/0187767 and 2018/0155455, and Int. Patent Appl. Publ. No. WO2018/098065, which are incorporated herein by reference.

At least one ester group of a graft copolymer in some aspects can comprise acyl group —CO—R′, wherein R′ comprises a chain of 1 to 26 carbon atoms. R′ can be linear, branched, or cyclic, for example. Examples of acyl groups herein that are linear include ethanoyl, propanoyl, butanoyl, pentanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, nonadecanoyl, eicosanoyl, uneicosanoyl, docosanoyl, tricosanoyl, tetracosanoyl, pentacosanoyl, and hexacosanoyl. Common names for some of the above-listed acyl groups are acetyl (ethanoyl group), propionyl (propanoyl group), butyryl (butanoyl group), valeryl (pentanoyl group), caproyl (hexanoyl group); enanthyl (heptanoyl group), caprylyl (octanoyl group), pelargonyl (nonanoyl group), capryl (decanoyl group), lauroyl (dodecanoyl group), myristyl (tetradecanoyl group), palmityl (hexadecanoyl group), stearyl (octadecanoyl group), arachidyl (eicosanoyl group), behenyl (docosanoyl group), lignoceryl (tetracosanoyl group), and cerotyl (hexacosanoyl group).

In some aspects, a glucan ester is an aryl ester; i.e., at least one ester group is an aryl ester group. An aryl ester group can comprise a benzoyl group (—CO—C₆H₅), for example, which can also be referred to as a benzoate group. An aryl ester group in some aspects can comprise a benzoyl group substituted with at least one halogen (“X”; e.g., Cl, F), alkyl, halogenated alkyl, ether, cyano, or aldehyde group, or combinations thereof, such as represented by the following Structures III(a) through III(r):

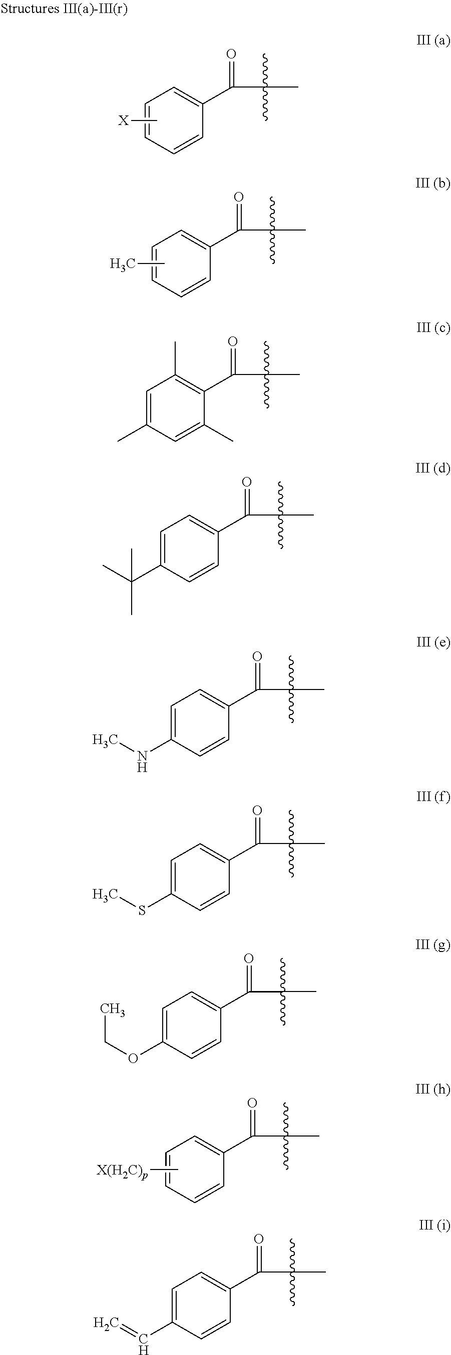

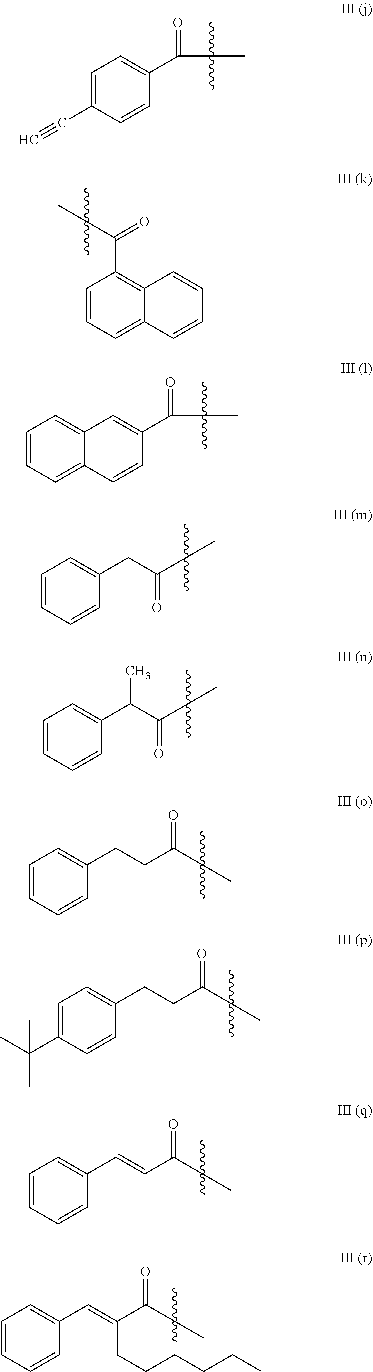

The glucan ester compounds in some aspects can contain one type of esterified acyl group. Examples of such compounds contain an acetyl group as the only esterified acyl group. Yet, in some aspects, graft copolymer ester compounds can contain two or more different types of esterified acyl groups (i.e., mixed ester of graft copolymer). Examples of such mixed esters include those with at least (i) acetyl and propionyl groups, (ii) acetyl and butyryl groups, and (iii) propionyl and butyryl groups. An ester derivative of an alpha-glucan homopolymer herein, in the presence or absence of a graft copolymer ester as presently disclosed, can have any of the foregoing mono-ester or mixed ester profiles. An alpha-glucan homopolymer mono- or mixed ester compound can be comprised in any composition/product/application as described herein, either with or without a dextran-alpha-glucan graft copolymer ether.

In one embodiment, the cleaning compositions comprise at least one organic acid derivative of mono- and diglycerides together with one or more functional polysaccharides (e.g. a glucan derivative), an enzyme and a polar protic solvent. In one embodiment, the organic acid derivative of mono- and diglyceride in the cleaning compositions provided herein can be any organic acid derivative of mono- and diglycerides available in the art.

Organic acid derivatives of mono- and diglycerides are surfactants typically used in food processing, for example in bakery applications, but also may be used as renewable anionic surfactants in laundry detergents. The organic acid derivative of mono- and diglycerides for use in the cleaning compositions provided herein include any organic acid derivative of mono- and di-glycerides and are selected from: citric acid esters of mono- and diglycerides (CITREM); tartaric acid esters of mono- and diglycerides (TATEM), diacetyltartaric acid esters of mono- and diglycerides (DATEM), and mixed acetic-, tartaric-, and di-acetylated tartaric acid esters of mono- and diglycerides (MATEM). In one embodiment, the organic acid derivative of mono- and diglycerides for use in the cleaning compositions provided herein is citric acid esters of mono- and diglycerides (CITREM). In another embodiment, the organic acid derivative of mono- and diglycerides for use in the cleaning compositions provided herein is diacetyltartaric acid esters of mono- and diglycerides (DATEM).

In some embodiments, the organic acid derivatives of mono- and diglycerides are present in the composition in an amount of 0.5% to 50% by weight of the composition. In another embodiment, the organic acid derivatives of mono- and diglycerides are present in an amount of 1% to 40% by weight of the composition. In still another embodiment, the organic acid derivatives of mono- and diglycerides are present in an amount of 5% to 40% by weight of the composition or in an amount of 10% to 40% by weight of the composition.

By “at least one organic acid derivatives of mono- and diglyceride” is to be understood that the detergent composition can comprise one, two, three, four, five, or more different organic acid derivatives of mono- and diglycerides in the cleaning composition. In some embodiments, the cleaning compositions provided herein include one or more organic acid derivatives of mono- and diglycerides, and optionally, one or more additional anionic surfactants.

The organic acid derivative or mono- and diglycerides can be in any physical form convenient for the preparation of a cleaning composition, including crystallized in block, flake or powder form or it can be a semi-liquid.

DATEM's can be sticky, waxy or highly viscous. In some embodiments, the organic acid derivative of mono- and diglycerides is a pumpable liquid composition. In one embodiment, the organic acid derivative of mono- and diglycerides is a pumpable liquid DATEM composition.

In one embodiment, the DATEM used in the cleaning compositions herein is a pumpable liquid composition comprising DATEM rich in DATEM I and/or DATEM Hand a diluent, and wherein said diluent is selected from the group of polar protic solvents and mixtures thereof.

In some embodiments, the CITREM and/or DATEM for use in the compositions herein is in the form of a liquid composition. In some embodiments, the liquid composition comprises CITREM and/or DATEM in an amount of from 20% to 99% by weight, based on the total weight of the liquid composition, where the DATEM compounds are rich in DATEM I and/or DATEM II, and a diluent in an amount of from 1 to 80% by weight, based on the total weight of the liquid composition, where the diluent is selected from the polar protic solvents and mixtures thereof. In some embodiments, the liquid CITREM and/or DATEM composition for use in the cleaning compositions provided herein include those described in U.S. Provisional Application No. 63/121,303, filed Dec. 4, 2020.

DATEM can be described by the chemical structures DATEM I through IV, which are the main chemical components of DATEM. In addition, DATEM compositions may contain unreacted mono- and mono-diglyceride, and triglyceride.

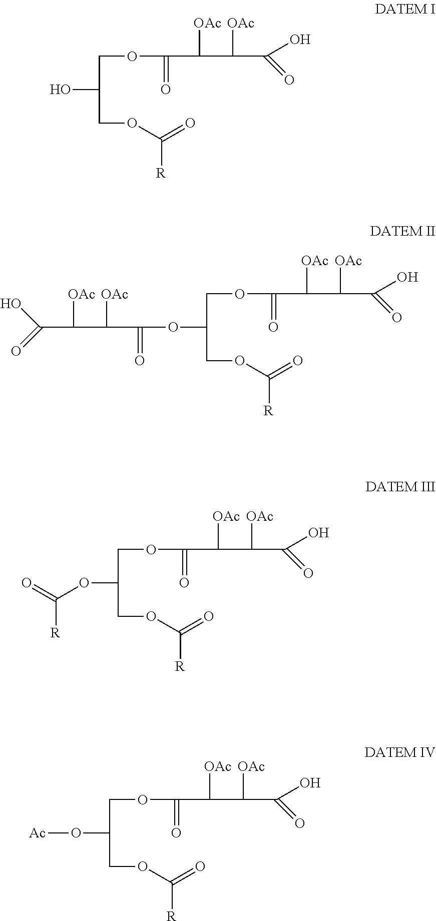

wherein R is a hydrocarbon chain, typically C₇ to C₂₁ alkyl-chains or alkenyl chains, i.e. hydrocarbon chains that are either saturated or contain one or more degrees of unsaturation. Typical fatty acids are described herein. Each of the molecules DATEM I-IV will have positional isomers wherein the position of each substituent or free hydroxyl group on the glycerol back bone may vary.

The diacetylated tartaric acid esters (DATEM) for use in the cleaning compositions of the present invention can be prepared from monoglycerides based on commercially available fats and oils containing saturated and/or unsaturated fatty acids of variable lengths (C8-C22). The prepared DATEM is thus based on saturated and/or unsaturated fatty acids of variable lengths (C8-C22).

In an embodiment the cleaning composition of the present invention comprises a pumpable liquid composition of diacetylated tartaric acid esters of monoglycerides (DATEM), where the monoglycerides are based on saturated and/or unsaturated fatty acids of variable lengths (C8-C22). The fatty acids can be independently selected from both saturated and unsaturated fatty acids such as but not limited to caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, alpha-linolenic acid, stearidonic acid, eicosapentaenoic acid, docosahexaenoic acid, linoleic acid, gamma-linolenic acid, dihomo-gamma-linolenic acid, arachidonic acid, docosatetraenoic acid, palmitoleic acid, vaccenic acid, paullinic acid, oleic acid, elaidic acid, gondoic acid, erucic acid, mead acid.

In an embodiment the composition of the present invention comprises DATEM compounds of DATEM I and DATEM II wherein the monoglycerides are based on saturated and/or unsaturated C12-C18 fatty acids.

In an embodiment the cleaning compositions of the present invention comprises DATEM compounds of DATEM I and DATEM II prepared from monoglycerides containing least 80% by weight, such as at least 85% by weight, such as at least 90% by weight, such as at least 95% by weight, such as at least 98% by weight of monoglycerides based on saturated and/or unsaturated C12-C18 fatty acids.

In an embodiment the cleaning composition of the present invention comprises DATEM compounds of DATEM I and DATEM II prepared from monoglycerides containing least 80% by weight, such as at least 85% by weight, such as at least 90% by weight, such as at least 95% by weight, such as at least 98% by weight of monoglycerides based on saturated and/or unsaturated C16-C18 fatty acids.

In an embodiment the cleaning composition of the present invention comprises DATEM compounds of DATEM I and DATEM II prepared from monoglycerides containing up to 20% by weight, such as up to 30% by weight, such as up to 40% by weight, such as up to 50% by weight, such as up to 60% by weight, such as up to 80% by weight, such as up to 100% by weight monoglycerides based on saturated C12-C18 fatty acids.

In an embodiment the cleaning composition of the present invention comprises DATEM compounds of DATEM I and DATEM II prepared from monoglycerides containing up to 20% by weight, such as up to 30% by weight, such as up to 40% by weight, such as up to 50% by weight, such as up to 60% by weight, monoglycerides based on saturated C16-C18 fatty acids.

In an embodiment the cleaning composition of the present invention comprises DATEM compounds rich in DATEM I and/or DATEM II prepared from monoglycerides containing at least 20% by weight, such as at least 30% by weight, such as at least 40% by weight, such as at least 50% by weight, such as at least 60% by weight, such as at least 80% by weight, such as at least 95% by weight monoglycerides based on unsaturated C12-C18 fatty acids.

In an embodiment the cleaning composition of the present invention comprises DATEM compounds rich in DATEM I and/or DATEM II prepared from monoglycerides containing at least 20% by weight, such as at least 30% by weight, such as at least 40% by weight, such as at least 50% by weight, such as at least 60% by weight, such as at least 80% by weight, such as at least 95% by weight monoglycerides based on unsaturated C16-C18 fatty acids.

In an embodiment the cleaning composition of the present invention comprises DATEM compounds rich in DATEM I and/or DATEM II comprising tartaric acid esters and fatty acid esters in a molar ratio [tartaric acid/monoglyceride] of from 0.8/1.0 to 2.0/1.0, such as from 1.0/1.0 to 2.0/1.0, such as from 1.2/1.0 to 2.0/1.0, such as from 1.4/1.0 to 2.0/1.0, such as from 1.5/1.0 to 2.0/1.0, as determined by hydrolysis of said DATEM compounds rich in DATEM I and/or DATEM II.

In an embodiment the pumpable DATEM for use in the cleaning composition of the present invention comprises a diluent selected from the group consisting of selected from water, glycerol and mixtures thereof in an amount of from 1% by weight, such as from 2%, such as from 3%, such as from 6%, such as from 8%, such as from 10, such as from 15%, such as from 20% by weight, based on the total weight of the liquid composition.

In an embodiment the pumpable DATEM for use in the cleaning composition of the present invention comprises a diluent selected from the group of polar protic solvents consisting of or selected from water, glycerol and mixtures thereof in an amount of up to 80% by weight, such as 75%, such as up to 70%, such as up to 65%, such as up to 60%, such as up to 50%, such as up to 40%, based on the total weight of the liquid composition.

In an embodiment the pumpable DATEM for use in the cleaning composition of the present invention has a combined amount of DATEM compounds rich in DATEM I and/or DATEM II and diluent of least 90% by weight, such as of at least 92% by weight, such as of at least 95% by weight, such as of at least 98% by weight, such as of at least 99% by weight, based on the total weight of the liquid composition.

The term ‘diluent’ indicates a diluting agent. In the present context the diluent decreases the viscosity of DATEM, thereby facilitating handling, transportation and/or pumping of the DATEM composition.

In one embodiment the diluent used is water in an amount between 0.5%-80%, preferably between 1%-75% and more preferably between 2%-70%.

In another embodiment the diluent used is glycerol in an amount of glycerol between 1%-80%, preferably between 3%-75%. More preferably between 6%-70%.

In one embodiment the diluent used is a blend of glycerol and water in any ratio between glycerol and water in an amount between 0.5%-80%, preferably between 1%-75% of the total product. More preferably between 2%-70%.

In an embodiment the pumpable DATEM for use in the cleaning composition of the present invention has a viscosity of up to 3000 Pa*s, preferably of up to 2000 Pa*s, more preferably of up to 1200 Pa*s, such as up to 1000 Pa*s, up to 900 Pa*s, up to 800 Pa*s or up to 700 Pa*s as measured at a shear rate of 50 1/s during a temperature sweep from 90-20° C. or 50-20° C. with a cooling rate of 1° C./min using measuring system CC27 in Anton Paar Physica MC301 rheometer.

In an embodiment the pumpable DATEM for use in the cleaning composition of the present invention has a viscosity of at least 0.05 Pa*s, such as of at least 0.1 Pa*s, such as of at least 0.5 Pa*s, such as of at least 1.0 Pa*s, such as of at least 1.5 Pa*s, such as of at least 2 Pa*s, such as of at least 5 Pa*, such as of at least 10 Pa*s measured at a shear rate of 50 1/s during a temperature sweep from 90-20° C. or 50-20° C. with a cooling rate of 1° C./min using measuring system CC27 in Anton Paar Physica MC301 rheometer.

The pumpable DATEM composition has a viscosity less than 50% of the viscosity of the pure DATEM, preferably less than 30% of the viscosity of the pure DATEM, more preferably less than 10% of the pure DATEM.

Viscosity of the DATEM components can be measured according to ISO3219, at a shear rate of 50 1/s during a temperature sweep from 90-20° C. or 50-20° C. with a cooling rate of 1° C./min using Bob-cup measuring system CC 27, Serial number 17307, using a 19 ml sample in an Anton Paar Physica MC301 rheometer. The samples are heated to the initial measuring temperature, i.e. either to 90 or 50° C., before being transferred to the rheometer.

The citric acid esters of mono- and diglycerides (CITREM) for use in the cleaning compositions of the present invention can be prepared from mixtures of citric acid (CA) and mono- and/or diacylglycerol (MAG and DAG).

For example, the CITREM for use in the compositions herein can be made by mixing citric acid (CA) and mono- and/or diacylglycerol (MAG and DAG) and heat to a given temperature (120-160° C. or 145° C.) and the reaction is continued until acid value has decreased below a specified value. The primary and dominating reactions are esterification between an acid groups in citric acid and a hydroxyl group on the mono/di-glyceride leading to the three main compounds. However, unwanted reactions will unavoidably happen. The unwanted reactions comprise fatty acid interesterification (fatty acids move from one glycerol in a glyceride or a CITREM to another) and esterification of more than one citric acid to one monoglyceride. Consequently, the resulting product will be a mixture of many different compounds.

CITREM for use in the compositions herein can be described by the chemical structures CITREM Types A, B, or C, which are the main chemical components of CITREM. In addition, CITREM compositions may contain unreacted mono- and mono-diglyceride, and triglyceride.

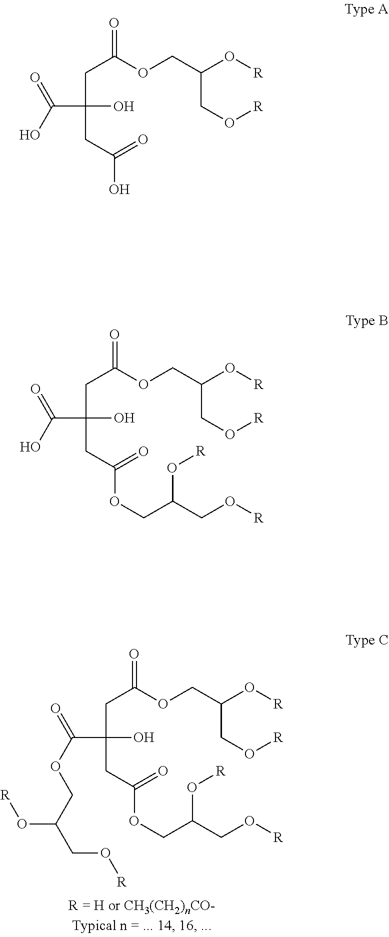

wherein R is a hydrocarbon chain, typically C14 or C16 alkyl-chains or alkenyl chains, i.e. hydrocarbon chains that are either saturated or contain one or more degrees of unsaturation. The CITREM for use in the compositions herein include any amount of citric acid in the CITREM product (bound in CITREMS or free). In one embodiment, the CITREM has a citric acid content greater than 13w/w % (>13w/w %) and may be referred to as E472e. In other embodiments, the CITREM has greater than 5w/w % citric acid (bound or free). The MAG and DAG mixture in the recipe can be any ratio from pure MAG to pure DAG (most often >90% MAG). The fatty acid composition in the MAG and or DAG can be as in the DATEM.

The organic acid derivative of mono- and diglyceride component for use in the cleaning compostion of the present invention may contain one or more further components, for example antioxidant, such as alpha tocopherol, or anti-microbial substances, such as potassium sorbate.

In some embodiments, the cleaning compositions comprise a surfactant system that comprises an organic acid derivative of mono- and di-glycerides in combination with one or more additional surfactants. The one or more additional surfactant may be either biobased or synthetic. In some embodiments, the one or more additional surfactants is selected from the group consisting of a non-ionic surfactant, an anionic surfactant, a cationic surfactant, a zwitterionic surfactant, an ampholytic surfactant, a semi-polar non-ionic surfactant, and a combination thereof.

In some embodiments, the cleaning compositions optionally comprise other anionic surfactants that are produced using renewable feedstocks, for example a rhamnolipid. Rhamnolipids are carboxylic acid containing anionic surfactants that consist of one or more alkyl chains connected via a beta hydroxy group to a rhamnose sugar. They may be produced from renewable raw materials as previously disclosed in, for example, WO2015180907. It is further optional to include nonionic, cationic or zwitterionic surfactants in the cleaning compositions.

The cleaning compositions as provided herein further comprise at least one cleaning enzyme. In some embodiments, the cleaning composition provided herein further comprises at least one protease, at least one alpha-amylase, or a combination of at least one protease and at least one alpha-amylase. In some embodiments, the cleaning compositions comprise additional cleaning enzymes in addition to the at least one protease, at least one alpha-amylase, or a combination of at least one protease and at least one alpha-amylase.

The protease for use in in the cleaning compositions of the instant disclosure include any polypeptide having protease activity. In one embodiment, the protease is a serine protease. In another embodiment, the protease is a metalloprotease, a fungal subtilisin, or an alkaline microbial protease or a trypsin-like protease. Suitable proteases include those of animal, vegetable or microbial origin. In some embodiments, the protease is a microbial protease. In other embodiments, the protease is a chemically or genetically modified mutant. In another embodiment, the protease is subtilisin like protease or a trypsin-like protease. In other embodiments, where two or more proteases are used in the cleaning compositions the protease do not contain cross-reactive epitopes with the variant as measured by antibody binding or other assays available in the art. Exemplary subtilisin proteases for use in the compositions provided herein include those variants derived from for example, Bacillus (e.g., BPN′, Carlsberg, subtilisin 309, subtilisin 147, and subtilisin 168), or fungal origin, such as, for example, those described in U.S. Pat. No. 8,362,222. Exemplary proteases include but are not limited to those described in WO92/21760, WO95/23221, WO2008/010925, WO09/149200, WO09/149144, WO09/149145, WO 10/056640, WO10/056653, WO2010/0566356, WO11/072099, WO2011/13022, WO11/140364, WO 12/151534, WO2015/038792, WO2015/089447, WO2015/089441, WO 2017/215925, US Publ. No. 2008/0090747, U.S. Pat. Nos. 5,801,039, 5,340,735, 5,500,364, 5,855,625, RE 34,606, U.S. Pat. Nos. 5,955,340, 5,700,676, 6,312,936, 6,482,628, 8,530,219, U.S. Provisional Appl Nos. 62/180,673 and 62/161,077, and PCT Appl Nos. PCT/US2015/021813, PCT/US2015/055900, PCT/US2015/057497, PCT/US2015/057492, PCT/US2015/057512, PCT/US2015/057526, PCT/US2015/057520, PCT/US2015/057502, PCT/US2016/022282, and PCT/US16/32514, as well as metalloproteases described in WO1999014341, WO1999033960, WO1999014342, WO1999034003, WO2007044993, WO2009058303, WO 2009058661, WO2014071410, WO2014194032, WO2014194034, WO 2014194054, and WO 2014/194117. Exemplary proteases include, but are not limited to trypsin (e.g., of porcine or bovine origin) and the Fusarium protease described in WO89/06270. Exemplary commercial proteases include, but are not limited to MAXATASE®, MAXACAL™, MAXAPEM™, OPTICLEAN®, OPTIMASE®, PROPERASE®, PURAFECT®, PURAFECT® OXP, PURAMAX™, EXCELLASE™, PREFERENZ™ proteases (e.g. P100, P110, P280), EFFECTENZ™ proteases (e.g. P1000, P1050, P2000), EXCELLENZ™ proteases (e.g. P1000), ULTIMASE®, and PURAFAST™ (DuPont); ALCALASE®, BLAZE®, BLAZE® variants, BLAZE® EVITY®, BLAZE® EVITY® 16L, CORONASE®, SAVINASE®, SAVINASE® ULTRA, SAVINASE® EVITY®, SAVINASE® EVERTS®, PRIMASE®, DURAZYM™, POLARZYME®, OVOZYME®, KANNASE®, LIQUANASE®, LIQUANASE EVERTS®, NEUTRASE®, PROGRESS UNO®, RELASE®, and ESPERASE® (Novozymes); BLAP™ and BLAP™ variants (Henkel); LAVERGY™ PRO 104 L (BASF). KAP (B. alkalophilus subtilisin (Kao)) and BIOTOUCH® (AB Enzymes).

Any amylase (e.g., alpha and/or beta) suitable for use in alkaline solutions may be useful to include in such composition. An exemplary amylase can be a chemically or genetically modified mutant. Exemplary amylases include, but are not limited to those of bacterial or fungal origin, such as, for example, amylases described in GB 1,296,839, WO9100353, WO9402597, WO94183314, WO9510603, WO9526397, WO9535382, WO9605295, WO9623873, WO9623874, WO 9630481, WO9710342, WO9741213, WO9743424, WO9813481, WO 9826078, WO9902702, WO 9909183, WO9919467, WO9923211, WO9929876, WO9942567, WO 9943793, WO9943794, WO 9946399, WO0029560, WO0060058, WO0060059, WO0060060, WO 0114532, WO0134784, WO 0164852, WO0166712, WO0188107, WO0196537, WO02092797, WO 0210355, WO0231124, WO 2004055178, WO2004113551, WO2005001064, WO2005003311, WO 2005018336, WO2005019443, WO2005066338, WO2006002643, WO2006012899, WO2006012902, WO2006031554, WO 2006063594, WO2006066594, WO2006066596, WO2006136161, WO 2008000825, WO2008088493, WO2008092919, WO2008101894, WO2008/112459, WO2009061380, WO2009061381, WO 2009100102, WO2009140504, WO2009149419, WO 2010/059413, WO 2010088447, WO2010091221, WO2010104675, WO2010115021, WO10115028, WO2010117511, WO 2011076123, WO2011076897, WO2011080352, WO2011080353, WO 2011080354, WO2011082425, WO2011082429, WO 2011087836, WO2011098531, WO2013063460, WO2013184577, WO 2014099523, WO2014164777, and WO2015077126. Exemplary commercial amylases include, but are not limited to AMPLIFY®, DURAMYL®, TERMAMYL®, FUNGAMYL®, STAINZYME®, STAINZYME PLUS®, STAINZYME PLUS®, STAINZYME ULTRA® EVITY®, and BAN™ (Novozymes); EFFECTENZ™ S 1000, POWERASE™, PREFERENZ™ S 100, PREFERENZ™ S 110, EXCELLENZ™ S 2000, RAPIDASE® and MAXAMYL® P (DuPont).

In one embodiment, the cleaning compositions as provided herein comprise from 0.001 to 0.2% enzyme protein by weight of the composition comprising at least one cleaning enzyme. In one embodiment, the cleaning compositions comprises from 0.001 to 0.2% enzyme protein by weight of the composition comprising at least one protease, at least one alpha-amylase or combination of at least one protease and at least one alpha-amylase. The cleaning compositions provided herein can also include additionalcleaning enzymes as provided in more detail below.

As used herein, the term “cleaning composition,” “detergent composition” or “detergent formulation” is used in reference to a composition intended for use in a wash medium (e.g. a wash liquor) for the cleaning of soiled or dirty objects, including particular textile or non-textile objects or items. Such compositions of the present invention are not limited to any particular detergent composition or formulation. Indeed, in some embodiments, the compositions of the invention comprise a functional polysaccharide, a derivative of a mono- and di-glyceride, and at least one protease, at least one alpha-amylase and, in addition, one or more additional components, such as, one or more additional surfactants, transferase(s), hydrolytic enzymes, oxido reductases, builders (e.g., a builder salt), bleaching agents, bleach activators, bluing agents, fluorescent dyes, caking inhibitors, masking agents, enzyme activators, antioxidants, and/or solubilizers. In some instances, a builder salt is a mixture of a silicate salt and a phosphate salt, preferably with more silicate (e.g., sodium metasilicate) than phosphate (e.g., sodium tripolyphosphate). Some compositions of the invention, such as, but not limited to, cleaning compositions or detergent compositions, do not contain any phosphate (e.g., phosphate salt or phosphate builder).

In some embodiments, the cleaning or detergent compositions of the present invention further comprise adjunct materials including, but not limited to, additional surfactants, builders, bleaches, bleach activators, bleach catalysts, other enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, fabric conditioners, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments, and pH control agents (See e.g., U.S. Pat. Nos. 6,610,642, 6,605,458, 5,705,464, 5,710,115, 5,698,504, 5,695,679, 5,686,014 and 5,646,101, all of which are incorporated herein by reference).

The detergent or cleaning compositions of the present invention are advantageously employed for example, in laundry applications, hard surface cleaning, dishwashing applications, as well as cosmetic applications such as dentures, teeth, hair and skin. In addition, due to the unique advantages of increased effectiveness in lower temperature solutions, the compositions of the present invention are ideally suited for laundry applications. Furthermore, the enzymes of the present invention find use in granular and liquid compositions.

Cleaning compositions, as provided herein, include, unless otherwise indicated, granular, powder, liquid, gel, paste, unit dose, bar form and/or flake type washing agents and/or fabric treatment compositions, including but not limited to products for laundering fabrics, fabric softening compositions, fabric enhancing compositions, fabric freshening compositions, and other products for the care and maintenance of fabrics, and combinations thereof. Such compositions may be pre-treatment compositions for use prior to a washing step or may be rinse added compositions, as well as cleaning auxiliaries, such as bleach additives and/or “stain-stick” or pre-treat compositions or substrate-laden products such as dryer added sheets.

Enzyme component weights are based on total active protein. All percentages and ratios are calculated by weight unless otherwise indicated. All percentages and ratios are calculated based on the total composition unless otherwise indicated. In laundry detergent compositions, the enzyme levels are expressed in ppm, which equals mg active protein/kg detergent composition.

In some embodiments, the laundry detergent compositions described herein further comprise one or more additional surfactant. In some embodiments, the additional surfactant is selected from a non-ionic, ampholytic, semi-polar, anionic, cationic, zwitterionic, and combinations and mixtures thereof. In yet a further embodiment, the additional surfactant is selected from an anionic surfactant, a cationic surfactant, a zwitterionic surfactant, and combinations thereof. In some embodiments, the laundry detergent compositions described herein comprise from about 0.1% to about 60%, about 1% to about 50%, or about 5% to about 40% surfactant by weight of the composition.

Exemplary additional surfactants include, but are not limited to sodium dodecylbenzene sulfonate, C12-14 pareth-7, C12-15 pareth-7, sodium C12-15 pareth sulfate, C14-15 pareth-4, sodium laureth sulfate (e.g., Steol CS-370), sodium hydrogenated cocoate, C12 ethoxylates (Alfonic 1012-6, Hetoxol LA7, Hetoxol LA4), sodium alkyl benzene sulfonates (e.g., Nacconol 90G), and combinations and mixtures thereof. Anionic surfactants include but are not limited to linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenyrisuccinic acid, or soap. Nonionic surfactants include but are not limited to alcohol ethoxylate (AEO or AE), carboxylated alcohol ethoxylates, nonylphenol ethoxylate, alkylpolyglycoside, alkyldimethylamine oxide, ethoxylated fatty acid monoethanolamide, fatty acid monoethanolamide, polyhydroxy alkyl fatty acid amide (e.g., as described in WO92/06154), polyoxyethylene esters of fatty acids, polyoxyethylene sorbitan esters (e.g., TWEENs), polyoxyethylene alcohols, polyoxyethylene isoalcohols, polyoxyethylene ethers (e.g., TRITONS and BRIJ), polyoxyethylene esters, polyoxyethylene-p-tert-octylphenols or octylphenyl-ethylene oxide condensates (e.g., NON P40), ethylene oxide condensates with fatty alcohols (e.g., LUBROL), polyoxyethylene nonylphenols, polyralkylene glycols (SYNPERONIC F108), sugar-based surfactants (e.g., glycopyranosides, thioglycopyranosides), and combinations and mixtures thereof.

In a further embodiment, the compositions described herein further comprise a surfactant mixture that includes, but is not limited to 5-15% anionic surfactants, <5% nonionic surfactants, cationic surfactants, phosphonates, soap, enzymes, perfume, butylphenyl methylpropionate, geraniol, zeolite, polycarboxylates, hexyl cinnamal, limonene, cationic surfactants, citronellol, and benzisothiazolinone.

The detergent compositions described herein may additionally include one or more detergent builders or builder systems, a complexing agent, a polymer, a bleaching system, a stabilizer, a foam booster, a suds suppressor, an anti-corrosion agent, a soil-suspending agent, an anti-soil redeposition agent, a dye, a bactericide, a hydrotope, an optical brightener, a fabric conditioner, and/or a perfume. The laundry detergent compositions described herein may also include additional enzymes selected from proteases, amylases, cellulases, lipases, mannanases, nucleases, pectinases, xyloglucanases, or perhydrolases.

In some embodiments, the detergent compositions described herein further comprises from about 1%, from about 3% to about 60% or even from about 5% to about 40% builder by weight of the cleaning composition. Builders may include, but are not limited to, the alkali metals, ammonium and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metals, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

In some embodiments, the builders form water-soluble hardness ion complexes (e.g., sequestering builders), such as citrates and polyphosphates (e.g., sodium tripolyphosphate and sodium tripolyphospate hexahydrate, potassium tripolyphosphate, and mixed sodium and potassium tripolyphosphate, etc.). Any suitable builder can find use in the compositions described herein, including those known in the art.

In some embodiments, the detergent compositions described herein further comprise an adjunct ingredient including, but not limited to additional surfactants, builders, bleaches, bleach activators, bleach catalysts, additional enzymes, an enzyme stabilizer (including, for example, an enzyme stabilizing system), chelants, optical brighteners, soil release polymers, dye transfer agents, dye transfer inhibiting agents, catalytic materials, hydrogen peroxide, sources of hydrogen peroxide, preformed peracids, polymeric dispersing agents, clay soil removal agents, structure elasticizing agents, dispersants, suds suppressors, dyes, perfumes, colorants, filler salts, hydrotropes, photoactivators, fluorescers, fabric conditioners, hydrolyzable surfactants, solvents, preservatives, anti-oxidants, anti-shrinkage agents, anti-wrinkle agents, germicides, fungicides, color speckles, anti-corrosion agents, alkalinity sources, solubilizing agents, carriers, processing aids, pigments, pH control agents, and combinations thereof. (See, e.g., U.S. Pat. Nos. 6,610,642, 6,605,458, 5,705,464, 5,710,115, 5,698,504, 5,695,679, 5,686,014, and 5,646,101). In some embodiments, one or more adjunct is incorporated for example, to assist or enhance cleaning performance, for treatment of the substrate to be cleaned, or to modify the aesthetics of the cleaning composition as is the case with perfumes, colorants, dyes or the like. Any such adjunct ingredient is in addition to the compositions comprising at least one organic acid derivative of mono- and diglycerides together with a glucan derivative, an enzyme and a polar protic solvent described herein. In some embodiments, the adjunct ingredient is selected from additional surfactants, enzyme stabilizers, builder compounds, polymeric compounds, bleaching agents, additional enzymes, suds suppressors, dispersants, lime-soap dispersants, soil suspension agents, softening agents, anti-redeposition agents, corrosion inhibitors, and combinations thereof.

In some further embodiments, the cleaning compositions described herein comprise one or more enzyme stabilizer. In some embodiments, the enzyme stabilizer is a water-soluble source of calcium and/or magnesium ions. In some embodiments, the enzyme stabilizers include oligosaccharides, polysaccharides, and inorganic divalent metal salts, including alkaline earth metals, such as calcium salts. In some embodiments, the enzymes employed herein are stabilized by the presence of water-soluble sources of zinc (II), calcium UI) and/or magnesium (11) ions in the finished compositions that provide such ions to the enzymes, as well as other metal ions (e.g., barium (II), scandium (II), iron (II), manganese (ii), aluminum tin (II), cobalt (II), copper (II), nickel (II), and oxovanadium (IV)). Chlorides and sulfates also find use in some embodiments. Exemplary oligosaccharides and polysaccharides (e.g., dextrins) are described, for example, in WO07145964. In some embodiments, the laundry detergent compositions described herein contain reversible protease inhibitors selected from a boron-containing compound (e.g., borate, 4-formyl phenyl boronic acid, and phenyl-boronic acid derivatives, such as, e.g., are described in WO9641859); a peptide aldehyde (such as, e.g., is described in WO2009118375 and WO2013004636), and combinations thereof.

The cleaning compositions herein are typically formulated such that, during use in aqueous cleaning operations, the wash water will have a pH of from about 3.0 to about 11. Liquid product formulations are typically formulated to have a neat pH from about 5.0 to about 9.0, more preferably from about 7.5 to about 9. Granular laundry products are typically formulated to have a pH from about 8.0 to about 11.0. Techniques for controlling pH at recommended usage levels include the use of buffers, alkalis, acids, etc., and are well known to those skilled in the art.

Suitable high pH cleaning compositions typically have a neat pH of from about 9.0 to about 11.0, or even a neat pH of from 9.5 to 10.5. Such cleaning compositions typically comprise a sufficient amount of a pH modifier, such as sodium hydroxide, monoethanolamine, or hydrochloric acid, to provide such cleaning composition with a neat pH of from about 9.0 to about 11.0. Such compositions typically comprise at least one base-stable enzyme. In some embodiments, the compositions are liquids, while in other embodiments, they are solids.

In one embodiment, the cleaning compositions include those having a pH of from 7.4 to pH 11.5, or pH 7.4 to pH 11.0, or pH 7.5 to pH 11.5, or pH 7.5 to pH 11.0, or pH 7.5 to pH 10.5, or pH 7.5 to pH 10.0, or pH 7.5 to pH 9.5, or pH 7.5 to pH 9.0, or pH 7.5 to pH 8.5, or pH 7.5 to pH 8.0, or pH 7.6 to pH 11.5, or pH 7.6 to pH 11.0, or pH 7.6 to pH 10.5, or pH 8.7 to pH 10.0, or pH 8.0 to pH 11.5, or pH 8.0 to pH 11.0, or pH 8.0 to pH 10.5, or pH 8.0 to pH 10.0.

Concentrations of detergent compositions in typical wash solutions throughout the world vary from less than about 800 ppm of detergent composition (“low detergent concentration geographies”), for example about 667 ppm in Japan, to between about 800 ppm to about 2000 ppm (“medium detergent concentration geographies”), for example about 975 ppm in U.S. and about 1500 ppm in Brazil, to greater than about 2000 ppm (“high detergent concentration geographies”), for example about 4500 ppm to about 5000 ppm in Europe and about 6000 ppm in high suds phosphate builder geographies.

In some embodiments, the detergent compositions described herein may be utilized at a temperature of from about 10° C. to about 60° C., or from about 20° C. to about 60° C., or from about 30° C. to about 60° C., from about 40° C. to about 60° C., from about 40° C. to about 55° C., or all ranges within 10° C. to 60° C. In some embodiments, the detergent compositions described herein are used in “cold water washing” at temperatures of from about 10° C. to about 40° C., or from about 20° C. to about 30° C., from about 15° C. to about 25° C., from about 15° C. to about 35° C., or all ranges within 10° C. to 40° C.

As a further example, different geographies typically have different water hardness. Water hardness is usually described in terms of the grains per gallon mixed Ca²⁺/Mg²⁺. Hardness is a measure of the amount of calcium (Ca²⁺) and magnesium (Mg²⁺) in the water. Most water in the United States is hard, but the degree of hardness varies. Moderately hard (60-120 ppm) to hard (121-181 ppm) water has 60 to 181 parts per million (parts per million converted to grains per U.S. gallon is ppm #divided by 17.1 equals grains per gallon) of hardness minerals.

TABLE I
Water Hardness Levels

| Water | Grains per gallon | Parts per million |
|---|---|---|
| Soft | less than 1.0 | less than 17 |
| Slightly hard | 1.0 to 3.5 | 17 to 60 |
| Moderately hard | 3.5 to 7.0 | 60 to 120 |
| Hard | 7.0 to 10.5 | 120 to 180 |
| Very hard | greater than 10.5 | greater than 180 |

European water hardness is typically greater than about 10.5 (for example about 10.5 to about 20.0) grains per gallon mixed Ca²⁺/Mg²⁺ (e.g., about 15 grains per gallon mixed Ca²⁺/Mg²⁺). North American water hardness is typically greater than Japanese water hardness, but less than European water hardness. For example, North American water hardness can be between about 3 to about 10 grains, about 3 to about 8 grains or about 6 grains. Japanese water hardness is typically lower than North American water hardness, usually less than about 4, for example about 3 grains per gallon mixed Ca²⁺/Mg²⁺.

In other embodiments, the composition described herein comprises one or more additional enzyme (e.g. in addition to the at least protease, at least one alpha-amylase or combination of at least one protease and at least one alpha-amylase in the compositions provided herein). The one or more additional enzyme is selected from acyl transferases, additional alpha-amylases, beta-amylases, alpha-galactosidases, arabinosidases, aryl esterases, beta-galactosidases, carrageenases, catalases, cellobiohydrolases, cellulases, chondroitinases, cutinases, DNases, endo-beta-1,4-glucanases, endo-beta-mannanases, esterases, exo-mannanases, galactanases, glucoamylases, hemicellulases, hexosaminidases, hyaluronidases, keratinases, laccases, lactases, ligninases, lipases, lipoxygenases, mannanases, metalloproteases, nucleases (e.g. deoxyribonucleases and ribonucleases), oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof. Some embodiments are directed to cleaning compositions as provided herein comprising a combination of enzymes (i.e., a “cocktail”) comprising enzymes like amylase, protease, lipase, mannanase, and/or nuclease.

The additional protease for use in in the compositions of the instant disclosure include any polypeptide having protease activity. In one embodiment, the protease is a serine protease. In another embodiment, the protease is a metalloprotease, a fungal subtilisin, or an alkaline microbial protease or a trypsin-like protease. Suitable proteases include those of animal, vegetable or microbial origin. In some embodiments, the protease is a microbial protease. In other embodiments, the protease is a chemically or genetically modified mutant. In another embodiment, the protease is subtilisin like protease or a trypsin-like protease. In other embodiments, the protease does not contain cross-reactive epitopes with the variant as measured by antibody binding or other assays available in the art. Exemplary subtilisin proteases for use in the compositions provided herein include those derived from for example, Bacillus (e.g., e.g., BPN′, Carlsberg, subtilisin 309, subtilisin 147, and subtilisin 168), or fungal origin, such as, for example, those described in U.S. Pat. No. 8,362,222. Exemplary proteases include but are not limited to those described in WO92/21760, WO95/23221, WO2008/010925, WO09/149200, WO09/149144, WO09/149145, WO 10/056640, WO10/056653, WO2010/0566356, WO11/072099, WO2011/13022, WO11/140364, WO 12/151534, WO2015/038792, WO2015/089447, WO2015/089441, WO 2017/215925, US Publ. No. 2008/0090747, U.S. Pat. Nos. 5,801,039, 5,340,735, 5,500,364, 5,855,625, RE 34,606, U.S. Pat. Nos. 5,955,340, 5,700,676, 6,312,936, 6,482,628, 8,530,219, U.S. Provisional Appl Nos. 62/180,673 and 62/161,077, and PCT Appl Nos. PCT/US2015/021813, PCT/US2015/055900, PCT/US2015/057497, PCT/US2015/057492, PCT/US2015/057512, PCT/US2015/057526, PCT/US2015/057520, PCT/US2015/057502, PCT/US2016/022282, and PCT/US16/32514, International publications WO2016001449, WO2016087617, WO2016096714, WO2016203064, WO2017089093, and WO2019180111, as well as metalloproteases described in WO1999014341, WO1999033960, WO1999014342, WO1999034003, WO2007044993, WO2009058303, WO 2009058661, WO2014071410, WO2014194032, WO2014194034, WO 2014194054, and WO 2014/194117. Exemplary proteases include, but are not limited to trypsin (e.g., of porcine or bovine origin) and the Fusarium protease described in WO89/06270. Exemplary commercial proteases include, but are not limited to MAXATASE®, MAXACAL™, MAXAPEM™, OPTICLEAN®, OPTIMASE®, PROPERASE®, PURAFECT®, PURAFECT® OXP, PURAMAX′, EXCELLASE™, PREFERENZ™ proteases (e.g. P100, P110, P280), EFFECTENZ™ proteases (e.g. P1000, P1050, P2000), EXCELLENZ™ proteases (e.g. P1000), ULTIMASE®, and PURAFAST™ (DuPont); ALCALASE®, BLAZE®, BLAZE® variants, BLAZE® EVITY®, BLAZE® EVITY® 16L, CORONASE®, SAVINASE®, SAVINASE® ULTRA, SAVINASE® EVITY®, SAVINASE® EVERTS®, PRIMASE®, DURAZYM™, POLARZYME®, OVOZYME®, KANNASE®, LIQUANASE®, LIQUANASE EVERTS®, NEUTRASE®, PROGRESS UNO®, RELASE®, and ESPERASE® (Novozymes); BLAP™ and BLAP™ variants (Henkel); LAVERGY™ PRO 104 L (BASF), KAP (B. alkalophilus subtilisin (Kao)) and BIOTOUCH® (AB Enzymes).

In some embodiments, the compositions provided herein comprise one or more additional amylases. In one embodiment, the composition comprises from about 0.00001% to about 10%, about 0.0001% to about 10%, about 0.001% to about 5%, about 0.001% to about 2%, or about 0.005% to about 0.5% amylase by weight composition. Any amylase (e.g., alpha and/or beta) suitable for use in alkaline solutions may be useful to include in such composition. An exemplary amylase can be a chemically or genetically modified mutant. Exemplary amylases include, but are not limited to those of bacterial or fungal origin, such as, for example, amylases described in GB 1,296,839, WO9100353, WO9402597, WO94183314, WO9510603, WO9526397, WO9535382, WO9605295, WO9623873, WO9623874, WO 9630481, WO9710342, WO9741213, WO9743424, WO9813481, WO 9826078, WO9902702, WO 9909183, WO9919467, WO9923211, WO9929876, WO9942567, WO 9943793, WO9943794, WO 9946399, WO0029560, WO0060058, WO0060059, WO0060060, WO 0114532, WO0134784, WO 0164852, WO0166712, WO0188107, WO0196537, WO02092797, WO 0210355, WO0231124, WO 2004055178, WO2004113551, WO2005001064, WO2005003311, WO 2005018336, WO2005019443, WO2005066338, WO2006002643, WO2006012899, WO2006012902, WO2006031554, WO 2006063594, WO2006066594, WO2006066596, WO2006136161, WO 2008000825, WO2008088493, WO2008092919, WO2008101894, WO2008/112459, WO2009061380, WO2009061381, WO 2009100102, WO2009140504, WO2009149419, WO 2010/059413, WO 2010088447, WO2010091221, WO2010104675, WO2010115021, WO10115028, WO2010117511, WO 2011076123, WO2011076897, WO2011080352, WO2011080353, WO 2011080354, WO2011082425, WO2011082429, WO 2011087836, WO2011098531, WO2013063460, WO2013184577, WO 2014099523, WO2014164777, and WO2015077126. Exemplary commercial amylases include, but are not limited to AMPLIFY®, DURAMYL®, TERMAMYL®, FUNGAMYL®, STAINZYME®, STAINZYME PLUS®, STAINZYME PLUS®, STAINZYME ULTRA® EVITY®, and BAN™ (Novozymes); EFFECTENZ™ S 1000, POWERASE™, PREFERENZ™ S 100, PREFERENZ™ S 110, EXCELLENZ™ S 2000, RAPIDASE® and MAXAMYL® P (DuPont).

In some embodiments, the compositions provided herein further comprise one or more lipases. In some embodiments, the composition comprises from about 0.00001% to about 10%, about 0.0001% to about 10%, about 0.001% to about 5%, about 0.001% to about 2%, or about 0.005% to about 0.5% lipase by weight composition. An exemplary lipase can be a chemically or genetically modified mutant. Exemplary lipases include, but are not limited to, e.g., those of bacterial or fungal origin, such as, e.g., H. lanuginosa lipase (see, e.g., EP 258068 and EP 305216), T. lanuginosa lipase (see, e.g., WO 2014/059360 and WO2015/010009), Rhizomucor miehei lipase (see, e.g., EP 238023), Candida lipase, such as C. antarctica lipase (e.g., C. antarctica lipase A or B) (see, e.g., EP 214761), Pseudomonas lipases such as P. alcaligenes and P. pseudoalcaligenes lipase (see, e.g., EP 218272), P. cepacia lipase (see, e.g., EP 331376), P. stutzeri lipase (see, e.g., GB 1,372,034), P. fluorescens lipase, Bacillus lipase (e.g., B. subtilis lipase (Dartois et al., Biochem. Biophys. Acta 1131:253-260 (1993)), B. stearothermophilus lipase (see, e.g., JP 64/744992), and B. pumilus lipase (see, e.g., WO 91/16422)). Exemplary cloned lipases include, but are not limited to Penicillium camembertii lipase (See, Yamaguchi et al., Gene 103:61-67 (1991)), Geotrichum candidum lipase (See, Schimada et al., J. Biochem., 106:383-388 (1989)), and various Rhizopus lipases, such as, R. delemar lipase (See, Hass et al., Gene 109:117-113 (1991)), R. niveus lipase (Kugimiya et al., Biosci. Biotech. Biochem. 56:716-719 (1992)) and R. oryzae lipase. Other lipolytic enzymes, such as cutinases, may also find use in one or more composition described herein, including, but not limited to, e.g., cutinase derived from Pseudomonas mendocina (see, WO 88/09367) and/or Fusarium solani pisi (see, WO90/09446). Exemplary commercial lipases include, but are not limited to M1 LIPASE™, LUMA FAST™, and LIPOMAX™ (DuPont); LIPEX®, LIPOCLEAN®, LIPOLASE® and LIPOLASE® ULTRA (Novozymes); and LIPASE P™ (Amano Pharmaceutical Co. Ltd).

In some embodiments, the compositions provided herein further comprise one or more mannanases. In one embodiment, the composition comprises from about 0.00001% to about 10%, about 0.0001% to about 10%, about 0.001% to about 5%, about 0.001% to about 2%, or about 0.005% to about 0.5% mannanase by weight composition. An exemplary mannanase can be a chemically or genetically modified mutant. Exemplary mannanases include, but are not limited to, those of bacterial or fungal origin, such as, for example, those described in WO 2016/007929; U.S. Pat. Nos. 6,566,114; 6,602,842; and 6,440,991: and U.S. Provisional Appl. Nos. 62/251,516, 62/278,383, and 62/278387. Exemplary commercial mannanases include, but are not limited to MANNAWAY® (Novozymes) and EFFECTENZ™ M 1000, EFFECTENZ™ M 2000, PREFERENZ® M 100, MANNASTAR®, and PURABRITE™ (DuPont).

In some embodiments, the compositions and methods provided herein further comprise nuclease, such as a DNase or RNase. Exemplary nucleases include, but are not limited to, those described in WO2015181287, WO2015155350, WO2016162556, WO2017162836, WO2017060475 (e.g. SEQ ID NO: 21), WO2018184816, WO2018177936, WO2018177938, WO2018/185269, WO2018185285, WO2018177203, WO2018184817, WO2019084349, WO2019084350, WO2019081721, WO2018076800, WO2018185267, WO2018185280, and WO2018206553. Other nucleases which can be used in the compositions and methods provided herein include those described in Nijland R, Hall M J, Burgess J G (2010) Dispersal of Biofilms by Secreted, Matrix Degrading, Bacterial DNase. PLoS ONE 5(12) and Whitchurch, C. B., Tolker-Nielsen, T., Ragas, P. C., Mattick, J. S. (2002) Extracellular DNA required for bacterial biofilm formation. Science 295: 1487.

Yet a still further embodiment is directed to a composition further comprising one or more cellulase. In one embodiment, the composition comprises from about 0.00001% to about 10%, 0.0001% to about 10%, about 0.001% to about 5%, about 0.001% to about 2%, or about 0.005% to about 0.5% cellulase by weight of composition. Any suitable cellulase may find use in a composition described herein. An exemplary cellulase can be a chemically or genetically modified mutant. Exemplary cellulases include but are not limited, to those of bacterial or fungal origin, such as, for example, those described in WO2005054475, WO2005056787, U.S. Pat. Nos. 7,449,318, 7,833,773, 4,435,307; EP 0495257; and U.S. Provisional Appl. No. 62/296,678. Exemplary commercial cellulases include, but are not limited to, CELLUCLEAN®, CELLUZYME®, CAREZYME®, ENDOLASE®, RENOZYME®, and CAREZYME® PREMIUM (Novozymes); REVITALENZ™ 100, REVITALENZ™ 200/220, and REVITALENZ® 2000 (DuPont); and KAC-500(B)™ (Kao Corporation). In some embodiments, cellulases are incorporated as portions or fragments of mature wild-type or variant cellulases, wherein a portion of the N-terminus is deleted (see, e.g., U.S. Pat. No. 5,874,276).

In some embodiments, the detergent compositions described herein further comprise at least one chelating agent. Suitable chelating agents may include, but are not limited to copper, iron, and/or manganese chelating agents, and mixtures thereof. In some embodiments, the laundry detergent compositions described herein comprises from about 0.1% to about 15% or even from about 3.0% to about 10% chelating agent by weight of composition.

In some embodiments, the at least one chelating agent including a biodegradable chelating agent. In one embodiment the composition further comprises, from 0.5% to 30% by weight of a biodegradable chelating agent selected from the group of sodium salts of glutamic acid diacetic acid (GLDA), methylglycinediacetic acid (MGDA), and itaconic acid.

In some still further embodiments, the detergent compositions described herein further comprise at least one deposition aid. Suitable deposition aids include, but are not limited to, polyethylene glycol, polypropylene glycol, polycarboxylate, soil release polymers such as polyterephthalic acid, clays such as kaolinite, montmorillonite, attapulgite, illite, bentonite, halloysite, and mixtures thereof.

In some embodiments, the detergent compositions described herein further comprise at least one anti-redeposition agent.

In some embodiments, the detergent compositions described herein further comprise one or more dye transfer inhibiting agent. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones, and polyvinylimidazoles, or mixtures thereof. In some embodiments, the detergent compositions described herein comprise from about 0.0001% to about 10%, from about 0.01% to about 5%, or even from about 0.1% to about 3% dye transfer inhibiting agent by weight of composition.

In some embodiments, the detergent compositions described herein further comprise one or more silicates. In some such embodiments, sodium silicates (e.g., sodium disilicate, sodium metasilicate, and crystalline phyllosilicates) find use. In some embodiments, the detergent compositions described herein comprise from about 1% to about 20% or from about 5% to about 15% silicate by weight of the composition.

In yet further embodiments, the detergent compositions described herein further comprise one or more dispersant. Suitable water-soluble organic materials include, but are not limited to the homo- or co-polymeric acids or their salts, in which the polycarboxylic acid comprises at least two carboxyl radicals separated from each other by not more than two carbon atoms.

In some embodiments, the detergent compositions described herein further comprise one or more bleach, bleach activator, and/or bleach catalyst. In some embodiments, the detergent compositions described herein comprise inorganic and/or organic bleaching compound(s). Inorganic bleaches may include, but are not limited to perhydrate salts (e.g., perborate, percarbonate, perphosphate, persulfate, and persilicate salts). In some embodiments, inorganic perhydrate salts are alkali metal salts. In some embodiments, inorganic perhydrate salts are included as the crystalline solid, without additional protection, although in some other embodiments, the salt is coated. Suitable salts include, for example, those described in EP2100949. Bleach activators are typically organic peracid precursors that enhance the bleaching action in the course of cleaning at temperatures of 60° C. and below. Bleach activators suitable for use herein include compounds which, under perhydrolysis conditions, give aliphatic peroxycarboxylic acids having preferably from about 1 to about 10 carbon atoms, in particular from about 2 to about 4 carbon atoms, and/or optionally substituted perbenzoic acid. Bleach catalysts typically include, for example, manganese triazacyclononane and related complexes, and cobalt, copper, manganese, and iron complexes, as well as those described in U.S. Pat. Nos. 4,246,612, 5,227,084, 4,810,410, WO9906521, and EP2100949.

In some embodiments, the detergent compositions described herein further comprise one or more catalytic metal complex. In some embodiments, a metal-containing bleach catalyst finds use. In other embodiments, the metal bleach catalyst comprises a catalyst system comprising a transition metal cation of defined bleach catalytic activity (e.g., copper, iron, titanium, ruthenium, tungsten, molybdenum, or manganese cations), an auxiliary metal cation having little or no bleach catalytic activity (e.g., zinc or aluminum cations), and a sequestrate having defined stability constants for the catalytic and auxiliary metal cations, particularly ethylenediaminetetraacetic acid, ethylenediaminetetra (methylenephosphonic acid) and water-soluble salts thereof are used (See, e.g., U.S. Pat. No. 4,430,243). In some embodiments, the laundry detergent compositions described herein are catalyzed by means of a manganese compound. Such compounds and levels of use are well known in the art (See, e.g., U.S. Pat. No. 5,576,282). In additional embodiments, cobalt bleach catalysts find use in the laundry detergent compositions described herein. Various cobalt bleach catalysts are known in the art (See, e.g., U.S. Pat. Nos. 5,597,936 and 5,595,967) and are readily prepared by known procedures.

Some embodiments are directed to a method of cleaning comprising contacting an effective amount of a cleaning composition described herein with an item or surface comprising a soil.

Other aspects and embodiments of the present compositions and methods will be apparent from the foregoing description and following examples. Various alternative embodiments beyond those described herein can be employed in practicing the invention without departing from the spirit and scope of the invention. Accordingly, the claims, and not the specific embodiments described herein, define the scope of the invention and as such methods and structures within the scope of the claims and their equivalents are covered thereby.

In another embodiment, the disclosure provides methods for washing a fabric or textile comprising: (i) contacting a fabric or textile with a cleaning composition comprising (a) from 0.1 to 10% by weight of a functional polysaccharide, (b) from 1% to 40% by weight of an organic acid derivative of mono- and diglyceride, (c) from 0.001 to 0.2% enzyme protein by weight of the composition comprising at least a protease and an alpha-amylase, and (d) from 0.5 to 10% of a polar protic solvent other than water; and (ii) optionally, rinsing the fabric or textile.

The fabric or textile can be contacted with the cleaning compositions provided herein in a washing machine or in a manual wash tub (e.g. for handwashing). In one embodiment, the fabric or textile is contacted with the cleaning composition in a wash liquor.

In some embodiments, the fabric or textiles are contacted with the cleaning compositions as provided herein under conditions for any amount of time desired or for any period of time sufficient to clean the fabric or textile. In one embodiment, the contacting step is between about 5 minutes and about 10 days. In some embodiments, the contacting takes place in a wash liquor for about 5 to about 400 minutes, between about 5 minutes to about 300 minutes, between about 5 minutes to about 250 minutes, between about 5 minutes to about 200 minutes, between about 5 minutes to about 150 minutes, between about 5 minutes to about 100 minutes, between about 5 minutes to about 50 minutes, between about 5 minutes to about 30 minutes.

In some embodiments, the textiles or articles are contacted with the cleaning compositions provided herein under conditions having a temperature that allows for cleaning the textile or fabric. In some embodiments, the temperature in the methods disclosed herein include those between 10° to 60° C., between 10° to about 45° C., between 15° to about 55° C., between 15° to about 50° C., between 15° to about 45° C., between 20° to about 60° C., between 20° to about 50° C. and between 20° to about 45° C.

Another embodiment is directed to a method of laundering a textile, where the method comprises contacting a fabric or textile with a cleaning composition comprising: (a) from 0.1 to 10% by weight of a functional polysaccharide, (b) from 1% to 40% by weight of an organic acid derivative of mono- and diglyceride, (c) from 0.001 to 0.2% enzyme protein by weight of the composition comprising at least a protease and an alpha-amylase, and (d) from 0.5 to 10% of a polar protic solvent other than water for an amount of time sufficient to clean the fabric or textile and optionally rinsing the fabric or textile.

### EXAMPLES

The following are illustrative examples of cleaning compositions according to the present disclosure and are not intended to be limiting. Ingredient inclusion levels are based on 100% active matter. Enzyme levels are reported as enzyme protein by weight of the composition.

TABLE 1
Heavy Duty Liquid laundry detergent compositions,
where A is a comparative cleaning composition primarily
formulated with petroleum based ingredients

| Ingredients | A | 1 | 2 | 3 | 4 | 5 | 6 |
|---|---|---|---|---|---|---|---|
| Na-C9-15 Linear | 7.50 | 7.50 | 7.50 | 7.50 | 6.00 | 4.50 | 4.50 |
| Alkylbenzene | | | | | | | |
| Sulfonate | | | | | | | |
| C18 DATEM (high | | 1.50 | 3.00 | 6.30 | 1.50 | 3.00 | 6.30 |
| oleic sunflower oil) | | | | | | | |
| Na-C12-15 alkyl | 6.30 | 4.80 | 3.30 | | 6.30 | 6.30 | 3.00 |
| ethoxy sulfate (EO2) | | | | | | | |
| Alcohols, C12-15, | 3.00 | 3.00 | 3.00 | 3.00 | 3.00 | 3.00 | 3.00 |
| ethoxylated (EO7) | | | | | | | |
| Na-Cocoate | 1.20 | 1.20 | 1.20 | 1.20 | 1.20 | 1.20 | 1.20 |
| Propylene glycol | 2.50 | | | | | | |
| Bio-PDO (1,3- | | 2.50 | 2.50 | 2.50 | 2.50 | 2.50 | 2.50 |
| propanediol) | | | | | | | |
| Acrylic homopolymer | 1.40 | | | | | | |
| Glucan derivative | | 1.40 | 1.40 | 1.40 | 1.40 | 1.40 | 1.40 |
| Sodium citrate | 2.60 | 2.60 | 2.60 | 2.60 | 2.60 | 2.60 | 2.60 |
| D-Sorbitol | 0.80 | 0.80 | 0.80 | 0.80 | 0.80 | 0.80 | 0.80 |
| Triethanolamine | 0.50 | 0.50 | 0.50 | 0.50 | 0.50 | 0.50 | 0.50 |
| Protease | 0.050 | 0.050 | 0.050 | 0.050 | 0.050 | 0.050 | 0.050 |
| Alpha-amylase | 0.010 | 0.010 | 0.010 | 0.010 | 0.010 | 0.010 | 0.010 |
| Mannanase | 0.005 | 0.005 | 0.005 | 0.005 | 0.005 | 0.005 | 0.005 |
| Cellulase | 0.001 | 0.001 | 0.001 | 0.001 | 0.001 | 0.001 | 0.001 |

| | |
|---|---|
| Water, perfume, | Balance |
| dyes & minors | |
| pH | 7.8-8.2 |

TABLE 2
Unit Dose Liquid laundry detergent compositions, where B is a comparative
cleaning composition primarily formulated with petroleum based ingredients

| Ingredients | B | 7 | 8 | 9 | 10 | 11 | 12 |
|---|---|---|---|---|---|---|---|
| TEA-C9-15 Linear | 19.20 | 16.00 | 12.80 | 9.60 | 6.40 | 3.20 | |
| Alkylbenzene Sulfonate | | | | | | | |
| C18 DATEM (high oleic | | 3.20 | 6.40 | 9.60 | 12.80 | 16.00 | 19.30 |
| sunflower oil) | | | | | | | |
| Na-C12-15 alkyl ethoxy | 1.90 | 1.90 | 1.90 | 1.90 | 1.90 | 1.90 | 1.90 |
| sulfate (EO2) | | | | | | | |
| Alcohols, C12-15, | 14.10 | 14.10 | 14.10 | 14.10 | 14.10 | 14.10 | 14.10 |
| ethoxylated (EO7) | | | | | | | |
| TEA-Cocoate | 13.50 | 13.50 | 13.50 | 13.50 | 13.50 | 13.50 | 13.50 |
| Propylene glycol | 8.10 | | | | | | |
| Bio-PDO (1,3- | | 8.10 | 8.10 | 8.10 | 8.10 | 8.10 | 8.10 |
| propanediol) | | | | | | | |
| Acrylic homopolymer | 3.60 | | | | | | |
| Glucan derivative | | 3.60 | 3.60 | 3.60 | 3.60 | 3.60 | 3.60 |
| Sodium citrate | 1.10 | 1.10 | 1.10 | 1.10 | 1.10 | 1.10 | 1.10 |
| Triethanolamine | 6.00 | 6.00 | 6.00 | 6.00 | 6.00 | 6.00 | 6.00 |
| Protease | 0.10 | 0.10 | 0.10 | 0.10 | 0.10 | 0.10 | 0.10 |
| Alpha-amylase | 0.030 | 0.030 | 0.030 | 0.030 | 0.030 | 0.030 | 0.030 |
| Mannanase | 0.010 | 0.010 | 0.010 | 0.010 | 0.010 | 0.010 | 0.010 |
| Cellulase | 0.003 | 0.003 | 0.003 | 0.003 | 0.003 | 0.003 | 0.003 |
| Water, perfume, dyes & | Balance | | | | | | |
| minors | | | | | | | |

| | |
|---|---|
| pH | 7.8-8.2 |

TABLE 3
Liquid hand dish wash compositions, where C is
a comparative cleaning composition primarily
formulated with petroleum based ingredients

| Ingredients | C | 13 | 14 | 15 | 16 | 17 | 18 |
|---|---|---|---|---|---|---|---|
| Na-C9-15 Linear | 7.50 | 5.00 | 2.50 | 7.50 | 7.50 | 7.50 | 7.50 |
| Alkylbenzene | | | | | | | |
| Sulfonate | | | | | | | |
| C18 DATEM (high | | 2.50 | 5.00 | 7.50 | 3.00 | 6.00 | 9.00 |
| oleic sunflower oil) | | | | | | | |
| Na-C12-15 alkyl | 9.00 | 9.00 | 9.00 | 9.00 | 6.00 | 3.00 | |
| ethoxy sulfate (EO1) | | | | | | | |
| Coco amido propyl | 4.0 | 4.0 | 4.0 | 4.0 | 4.0 | 4.0 | 4.0 |
| betaine | | | | | | | |
| Ethanol | 2.5 | 2.5 | 2.5 | 2.5 | 2.5 | 2.5 | 2.5 |
| PEI-EO-PO block | 0.80 | | | | | | |
| polymer | | | | | | | |
| Glucan derivative | | 0.80 | 0.80 | 0.80 | 0.80 | 0.80 | 0.80 |
| Sodium citrate | 0.20 | 0.20 | 0.20 | 0.20 | 0.20 | 0.20 | 0.20 |
| Protease | 0.010 | 0.010 | 0.010 | 0.010 | 0.010 | 0.010 | 0.010 |
| Alpha-amylase | 0.010 | 0.010 | 0.010 | 0.010 | 0.010 | 0.010 | 0.010 |
| Water, perfume, | Balance | | | | | | |
| dyes & minors | | | | | | | |

| | |
|---|---|
| pH | 7.0-7.5 |

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

1. A cleaning composition comprising: (a) from 1% to 40% by weight of an organic acid derivative of mono- and diglycerides, (b) from 0.1 to 10% by weight of a functional polysaccharide, (c) an enzyme system comprising from 0.001 to 0.2% enzyme protein by weight of the composition comprising at least a protease and an alpha-amylase, and (d) from 0.5 to 10% by weight of a polar protic solvent other than water.

2. The composition according to claim 1 wherein the organic acid derivative of mono- and diglycerides is selected from a citric acid ester of mono- and diglycerides (CITREM), a diacetyltartaric acid ester of mono- and diglycerides (DATEM) and mixtures thereof.

3. The composition according to claim 1 wherein the organic acid derivative of mono- and diglycerides is a pumpable liquid composition comprising a CITREM, a DATEM, or a combination of a CITREM and a DATEM in an amount of from 20 to 99% by weight, based on the total weight of the liquid composition, and a diluent in an amount of from 1 to 80% by weight, based on the total weight of the liquid composition, wherein said DATEM is rich in DATEM I and/or DATEM II, and wherein said diluent is selected from the group of polar protic solvents and mixtures thereof.

4. The composition according to claim 1 wherein the functional polysaccharide is a hydrocolloid thickener selected from the group of xanthan gum, galactomannans, guar, alginate, carrageenan, starch, gellan, carboxymethyl cellulose and mixtures thereof.

5. The composition according to claim 1 wherein the functional polysaccharide is an enzymatically produced glucan which comprises 1,2-, 1,3-, 1,4-, 1,6-, 1,2,6-, 1,3,6-, 1,4,6-alpha glycosidic linkages or various combinations thereof, and the glucan is derivatized by one or more polyether groups, one or more polyamine groups, or a combination of polyether and polyamine groups.

6. The composition according to claim 1 wherein the functional polysaccharide is an enzymatically produced glucan which comprises 1,2-, 1,3-, 1,4-, 1,6-, 1,2,6-, 1,3,6-, 1,4,6-alpha glycosidic linkages or various combinations thereof, and the polyglucan is derivatized by one or more hydrophobic organic group, one or more hydrophilic organic group, or both a hydrophobic and a hydrophilic organic group.

7. The composition according to claim 1 wherein the functional polysaccharide is an enzymatically produced glucan which comprises 1,2-, 1,3-, 1,4-, 1,6-, 1,2,6-, 1,3,6-, 1,4,6-alpha glycosidic linkages or various combinations thereof, and the polyglucan is derivatized by one or more hydrophobic ester group selected from an aryl ester group, a first ester group comprising a first acyl group —CO—R″ wherein R″ comprises a chain of 1 to 24 carbon atoms, a second ester group comprising a second acyl group —CO—Cₓ—COOH wherein —Cₓ— comprises a chain of 2 to 24 carbon atoms, or a combination thereof.

8. The composition according to claim 1 wherein the enzyme system comprises a protease and an alpha-amylase, and optionally other enzyme functionalities such as a mannanase, cellulase, lipase, cutinase, perhydrolase, pectate lyase, galactanase, glycosyl hydrolase, nuclease, and a phosphodiesterase.

9. The composition according to claim 1 where the polar protic solvent is selected from the group of water, glycerol, 1,2-propanediol, 1,3-propanediol, ethanol, isopropylalcohol, and mixtures thereof.

10. The composition according to claim 1 wherein the composition further comprising a surfactant system comprising anionic, nonionic, cationic or zwitterionic surfactants or mixtures thereof.

11. The composition according to claim 1 wherein the surfactant system includes a rhamnolipid.

12. The composition according to claim 1 wherein the polar protic solvent is a biologically-derived 1,3-propanediol.

13. The composition according to claim 1, wherein the composition further comprises, from 0.5% to 30% by weight of a biodegradable chelating agent selected from the group of sodium salts of glutamic acid diacetic acid (GLDA), methylglycinediacetic acid (MGDA), and itaconic acid.

14. A method for cleaning a fabric or a surface comprising (i) forming an aqueous wash liquor by dissolving a cleaning composition comprising (a) from 1% to 40% by weight of an organic acid derivative of mono- and diglycerides, (b) from 0.1 to 10% by weight of a functional polysaccharide, (c) from 0.001 to 0.5% enzyme protein by weight of the composition comprising at least a protease and an alpha-amylase, and (d) from 0.5 to 10% by weight of a polar protic solvent other than water; and (ii) contacting a fabric or surface with the aqueous wash liquor for from 1 to 50 minutes in a washing step; and (iii) optionally rinsing and drying said fabric or surface.

15. The method of claim 14, wherein the functional polysaccharide is an enzymatically produced polyglucan which comprises 1,2-, 1,3-, 1,4-, 1,6-, 1,2,6-, 1,3,6-, 1,4,6-alpha glycosidic linkages or various combinations thereof, and the polyglucan is derivatized by at least one charged organic group.
